(19) United States
(12) Patent Application Publication
(10) Pub. No.: US 2026/0070598 A1
(43) Pub. Date: Mar. 12, 2026

(54) SACRIFICIAL SCUFF PANEL FOR WHEELED CARTS

(71) Applicant: The Peggs Company, Inc., Riverside, CA (US)

(72) Inventors: Brett Nelson, Riverside, CA (US); Michael Wolfe, Riverside, CA (US)

(73) Assignee: The Peggs Company, Inc., Riverside, CA (US)

(21) Appl. No.: 19/325,440

(22) Filed: Sep. 10, 2025

Related U.S. Application Data
(60) Provisional application No. 63/693,661, filed on Sep. 11, 2024.

(51) Int. Cl. B62B 3/18

(52) U.S. Cl. CPC B62B 3/18

(57) ABSTRACT

Wheeled carts are disclosed and in particular shopping carts. In preferred embodiments, the wheeled cart comprises a structural frame with a left vertical support and a right vertical support. The wheeled cart has a basket and a plurality of wheels coupled to the structural frame. The wheeled cart further comprises a left scuff plate removably coupled to the left vertical support and a right scuff plate removably coupled to the right vertical support. The left scuff plate and the right scuff plate comprise the widest points on the wheeled cart over at least an entire vertical height of the basket.

### FIELD OF THE INVENTION

The present invention generally relates to wheeled carts such as those used in retail and grocery stores. More particularly, the present invention relates to a wheeled cart having sacrificial scuff plates which can be used for advertising.

### BACKGROUND OF THE INVENTION

Shopping carts (i.e., grocery carts, wheeled carts) are commonly provided to a customer by retail stores as a convenient method to collect items and to transport them through the store and, if needed, ultimately to the customer's automobile. Most commonly, a shopping cart is designed to nest into a preceding identical cart and to enable a following identical cart to be nested into the shopping cart itself. In retail stores and their parking areas, long lines of nested shopping carts are generally formed and moved by store employees or even by customers. The metal tube frame of a typical shopping cart commonly has one or more baskets and has at least two front and two rear wheels, or casters. In general, the rear wheels do not swivel whereas the front wheels do, allowing the customer to steer, push and pull the shopping cart as needed.

Various parts of the shopping cart are exposed to severe abuse during use and from environmental conditions. For example, shopping carts may strike and impact various obstacles inside and outside the retail store. Furthermore, environmental conditions such as sun, snow, rain and ice may cause rust or other related degradation issues as these shopping carts are left outside for prolonged periods of time. Further contaminants such as salt, beverages and dirt can also get into the casters causing enhanced wear and reduced performance.

Accordingly, there is a need for an improved shopping cart that can survive the service conditions with reduced operating expenses and longer maintenance or replacement intervals. The present invention fulfills these needs and provides other related advantages.

### SUMMARY OF THE INVENTION

An exemplary embodiment of a wheeled cart 1 of the present invention comprises a structural frame, a basket and a plurality of wheels. The structural frame 10 has a left vertical support 11 extending at least vertically from a bottom left end 12 to a top left end 13 and a right vertical support 14 extending at least vertically from a bottom right end 15 to a top right end 16. The left vertical support is disposed a frame width 17 apart from the right vertical support. A bottom horizontal support 18 is connected to the left and the right vertical supports. A rear end cross brace 19 is connected between the bottom left end and the bottom right end of the left vertical support and the right vertical support. The bottom horizontal support extends at least horizontally in a forward direction 20 from the left and right vertical supports or from the rear end cross brace to a front end 21 of the bottom horizontal support. The bottom horizontal support has a U-shape. The structural frame is a monolithic (i.e., single part) reinforced injection molded plastic part. The bottom horizontal support comprises a lower shelf 22 configured to retain an item placed on the lower shelf by a user. The lower shelf may be integrally formed as part of the monolithic injection molded plastic part or the lower shelf may be separately manufactured and attached to the bottom horizontal support. The left vertical support includes a plurality of left frame fixturing holes 23. Similarly, the right vertical support includes a plurality of right frame fixturing holes 24.

At least one nesting stop 25 is extending inwardly from the bottom horizontal support. The at least one nesting stop is disposed between the front end of the bottom horizontal support and the rear end cross brace. The at least one nesting stop is configured to abut the front end of a similarly designed second wheeled cart 2 when the second wheeled cart is nested within the wheeled cart. The at least one nesting stop comprises a left-side nesting stop 26 and a right-side nesting stop 27. The left-side nesting stop is configured to abut a left-side front end 28 of the second wheeled cart and the right-side nesting stop is configured to abut a right-side front end 29 of the second wheeled cart.

At least one left front wheel fixturing hole 91 is disposed through the structural frame located at or near the left-side front end. At least one right front wheel fixturing hole 92 is disposed through the structural frame located at or near the right-side front end. At least one left rear wheel fixturing hole 93 is disposed through the structural frame located at or near the bottom left end of the left vertical support. At least one right rear wheel fixturing hole 94 is disposed through the structural frame located at or near the bottom right end of the right vertical support.

A plurality of wheels 30 are rotatably attached to the structural frame. The plurality of wheels comprises a left front wheel 31, a right front wheel 32, a left rear wheel 33 and a right rear wheel 34 each rotatably attached to the structural frame and configured to roll upon a horizontal surface 35 in unison, the horizontal surface being a common ground plane 35. The left rear wheel is rotatably attached to the structural frame at or near the bottom left end. The right rear wheel is rotatably attached to the structural frame at or near the bottom right end. The left rear wheel and the right rear wheel are aligned along a common rear axis 36 and comprise rigid casters. The left front wheel is rotatably attached to the structural frame at or near the left-side front end of the bottom horizontal support. The right front wheel is rotatably attached to the structural frame at or near the right-side front end of the bottom horizontal support. The left front wheel and the right front wheels comprise swivel casters 37.

A basket 40 is configured to be disposed within the frame width and attach to the structural frame. The basket comprises a basket floor 41 extending at least horizontally and connected to a left-side wall 42, a front wall 43 and a right-side wall 44. A rear wall 45 gate assembly is pivotably attached to the left-side wall and the right-side wall at or near the top left end and the top right end. The left-side wall, the front wall and the right-side wall each extend at least vertically. A top 46 of the basket is open, wherein the basket is configured to retain the item placed upon the basket floor by the user. The basket floor is angled upwards in relation to the common ground plane extending from the rear wall towards the front wall. The left-side wall is angled inwards towards a center plane 57 of the basket extending from the rear wall towards the front wall in a left plane 58 that is perpendicular to the common ground plane. The right-side wall is angled inwards towards the center plane of the basket extending from the rear wall towards the front wall in a right plane 59 that is perpendicular to the common ground plane. The left-side wall includes a plurality of left-side wall studs 47 extending outwardly and configured to match the spacing of the plurality of left frame fixturing holes and extend therethrough. The right-side wall includes a plurality of right-side wall studs 48 extending outwardly and configured to match the spacing of the plurality of right frame fixturing holes and extend therethrough. A plurality of fasteners 49 are for securing the basket to the structural frame by engaging the plurality of wall studs extending through the plurality of fixturing holes. The plurality of fasteners comprises spring push nuts (alternatively push-on external retaining rings, push-on retaining caps, rectangular push-on external retaining rings, flanged push-on external retaining rings, size-mount external retaining rings, round push nuts, rectangular push nuts, flanged push nuts, speed nuts).

The rear wall includes a secondary rear wall 50, also known as a back rest, pivotably connected to the rear wall at a bottom 51 of the rear wall. The secondary rear wall 50, (back rest) is configured to pivotably open towards an inside of the basket. An intermediate platform 52, which may form a seat, is pivotably connected to the rear wall at a proximal end 53 and has an engagement feature 54 at a distal end 55. The engagement feature is configured to engage the secondary rear wall in horizontal position. The rear wall includes at least one aperture 56, such that a child can sit upon the intermediate platform (seat) with a child's legs disposed through the at least one aperture.

The basket is a separately manufactured part in comparison to the structural frame. The left-side wall, the front wall, the right-side wall and the basket floor are a monolithic (i.e., single part) injection molded plastic part.

A handle 38 is horizontally disposed extending between and attached to the top left end and the top right end of the structural frame. The handle is configured to be engaged by the user of the wheeled cart. The handle may comprise at least one cup holder 39.

At least one nesting roller 60 is rotatably connected to the structural frame. The at least one nesting roller is disposed a distance 61 above and facing the common ground plane. The at least one nesting roller is disposed below the rear end cross brace. The at least one nesting roller does not have any parts of the wheeled cart between the at least one nesting roller and the common ground plane. The at least one nesting roller is disposed between the left and the right vertical supports. The bottom horizontal support includes an upper surface 62 facing the basket, wherein the at least one nesting roller is configured to abut a second upper surface 72 of the bottom horizontal support of the second wheeled cart when the second wheeled cart is nested within the wheeled cart. The upper surface comprises an angled portion 63 that transitions into a flat portion 64, wherein the angled portion is angled upwards in relation to the common ground plane extending from the front end towards the rear end cross brace, and wherein the flat portion is parallel to the common ground plane. The flat portion extends a distance of at least 1.0, 1.5, 2.0, 2.5, 2.75, 3 inches. The flat section (64) could also be a cradle to hold the roller, or a declining plane to hold the roller.

A bottommost point 65 of the at least one nesting roller has a distance 66 that is shorter to the common ground plane in comparison to a distance 67 from the flat portion of the upper surface to the common ground plane. When the second wheeled cart is nested within the wheeled the cart, the at least one nesting roller is configure to engage and rolls upon the second upper surface of the second wheeled cart and is configured to raise the left rear wheel and right rear wheel of the wheeled cart off the common ground plane.

The at least one nesting roller comprises a left-side roller 60l and a right-side roller 60r, wherein the upper surface comprises a left-side upper surface 68 and a right-side upper surface 69. The left-side roller is configured to engage a second left-side upper surface 78 of the second wheeled cart and the right-side roller is configured to engage a second right-side upper surface 79 of the second wheeled cart when the second wheeled cart is nested within the wheeled the cart. When the second wheeled cart is nested within the wheeled cart, the at least one nesting stop abuts the front end of the second wheeled cart while the at least one nesting roller is positioned upon the flat portion of the second upper surface of the second wheeled cart.

The rear end cross brace comprises a horizontal roof portion 80 having a front wall 81 and rear wall 82 extending downward forming a channel 95, wherein the at least one nesting roller is disposed within the channel.

The at least one nesting roller comprises a blind hole 84 having a female thread on one side opposite an axle extension 86 on the other side. A shoulder screw 83 has a male thread 85 adjacent a shoulder portion 96. The shoulder screw is attached to the at least one nesting roller with the male thread threadedly engaging the female thread of the at least one nesting roller. The at least one nesting roller may have a frustoconical shape, where a narrowing of the frustoconical shape is away from the axle extension. The structural frame includes a through hole configured for the shoulder portion to reside within when the at least one nesting roller is attached to the structural frame. The structural frame includes a U-shaped recess configured for the axle extension to reside within when the at least one nesting roller is attached to the structural frame.

In another aspect of the inventions disclosed herein, a wheeled cart with scuff plates is provided. In preferred embodiments, the wheeled cart with scuff plates comprises a structural frame with a left vertical support and a right vertical support. Attached to the structural frame is a plurality of rotatably attached wheels and a basket. A left scuff plate is removably coupled to the left vertical support and a right scuff plate is removably coupled to the right vertical support. The left scuff plate and right scuff plate define the widest points on the wheeled cart over at least an entire vertical height of the basket.

In other embodiments, the left scuff plate and right scuff plate define the widest points on the wheeled cart from at least a top of the basket to a bottom of a bottom shelf.

In still yet other embodiments, the left scuff plate and the right scuff plate define the widest points on the wheeled cart from at least the top of a handle to a bottom of a bottom shelf.

In still yet other embodiments, the left scuff plate and the right scuff plate comprise the widest points on the wheeled cart from at least the top of a handle to a top of the plurality of wheels.

In preferred embodiments, the left scuff plate and the right scuff plate are each coupled to the structural frame of the wheeled cart with fasteners.

In various different embodiments, the scuff plates may be designed differently. In some embodiments, the left scuff plate and the right scuff plate each comprise a spring portion that runs substantially along a vertical height of the left scuff plate and the right scuff plate.

In different embodiments, the scuff plates may cover different amounts of the side of the structural frame of the wheeled cart. In some embodiments, the left scuff plate covers 90% or more of an outside surface of the left vertical support and the right scuff plate covers 90% or more of an outside surface of the right vertical support. In other embodiments, the left scuff plate covers 95% or more of an outside surface of the left vertical support and the right scuff plate covers 95% or more of an outside surface of the right vertical support.

Although the scuff plates can be made from any material, preferably, the left scuff plate and the right scuff plate are comprised of injection molded plastic.

In some embodiments, the widest points defined by the scuff plates create a line running down a vertical length of the left scuff plate and the right scuff plate. In some embodiments, the widest points defined by the scuff plates create a centerline running down a vertical length of the left scuff plate and the right scuff plate.

In yet another aspect of the inventions disclosed and taught herein, a method of advertising with wheeled carts is provided. In preferred embodiments, the method of advertising with wheeled carts comprises obtaining a plurality of wheeled carts with a structural frame and obtaining a plurality of scuff plates designed to be removably coupled to the structural frame. The plurality of scuff plates includes a first scuff plate with a first advertisement and a second scuff plate with the first advertisement or a second advertisement different from the first advertisement. The first scuff plate with the first advertisement is coupled to a first wheeled cart in the plurality of wheeled carts and the second scuff plate with the first advertisement or the second advertisement is coupled to a second wheeled cart in the plurality of wheeled carts. The first wheeled cart includes a first additional scuff plate from the plurality of scuff plates and the second wheeled cart comprises a second additional scuff plate from the plurality of scuff plates. The first scuff plate and the first additional scuff plate comprise the widest points over at least an entire vertical height of a basket on the first wheeled cart and the second scuff plate and the second additional scuff plate comprise the widest points over at least an entire vertical height of a basket on the second wheeled cart.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

FIG. 1 is a three-dimensional isometric view of an exemplary wheeled cart embodying the present invention;

FIG. 2 is another three-dimensional isometric view of the structure of FIG. 1 taken from a different perspective;

FIG. 3 is another three-dimensional isometric view of the structure of FIG. 1 taken from a different perspective;

FIG. 4 is another three-dimensional isometric view of the structure of FIG. 1 taken from a different perspective;

FIG. 5 is a front view of the structure of FIG. 1;

FIG. 6 is a rear view of the structure of FIG. 1;

FIG. 7 is a left-side view of the structure of FIG. 1;

FIG. 8 is a right-side view of the structure of FIG. 1;

FIG. 9 is a top view of the structure of FIG. 1;

FIG. 10 is a bottom view of the structure of FIG. 1;

FIG. 11 is a three-dimensional isometric view of the structural frame taken from the exemplary wheeled cart of FIG. 1 now shown in isolation;

FIG. 12 is another three-dimensional view of the structure of FIG. 11 taken from a different perspective;

FIG. 13 is another three-dimensional view of the structure of FIG. 11 taken from a different perspective;

FIG. 14 is a front view of the structure of FIG. 11;

FIG. 15 is a rear view of the structure of FIG. 11;

FIG. 16 is a left-side view of the structure of FIG. 11;

FIG. 17 is a right-side view of the structure of FIG. 11;

FIG. 18 is a top view of the structure of FIG. 11;

FIG. 19 is a bottom view of the structure of FIG. 11;

FIG. 20 is an enlarged isometric view of the top of the vertical supports of the structural frame of the present invention;

FIG. 21 is an enlarged isometric view of the middle of the vertical supports of the structural frame of the present invention;

FIG. 22 is an enlarged isometric view of the bottom of the vertical supports and the bottom horizontal support near the rear end of the structural frame of the present invention;

FIG. 23 is an enlarged isometric view of the bottom horizontal support near the front end of the structural frame of the present invention;

FIG. 24 is an exploded isometric view of the present invention where the basket has been removed from the structural frame;

FIG. 25 is the exploded isometric view from FIG. 24 now at a different perspective;

FIG. 26 is a three-dimensional isometric view of the basket taken from the exemplary wheeled cart of FIG. 1 now shown in isolation;

FIG. 27 is an exploded isometric view of the structure of FIG. 1 now showing the scuff plate removed from the structural frame;

FIG. 28 is an isometric view of the structure of FIG. 1 now showing the scuff plate removed revealing the fastening means disposed therein;

FIG. 29 is an enlarged view of the structure of FIG. 28 taken near the top;

FIG. 30 is an enlarged view of the structure of FIG. 28 taken near the bottom;

FIG. 31 is a three-dimensional isometric view of the lower platform taken from the exemplary wheeled cart of FIG. 1 now shown in isolation;

FIG. 32 is another three-dimensional isometric view of the structure of FIG. 31 taken from a different perspective;

FIG. 33 is an enlarged isometric view showing a nesting roller of the present invention;

FIG. 34 is an isometric view showing the nesting roller and nesting stop of the present invention;

FIG. 35 is a side sectional view of the present invention showing the rolling surfaces and the nesting rollers;

FIG. 36A is an isometric view of the fastener and nesting roller of the present invention;

FIG. 36B is an isometric view of the nesting roller now showing its axle extension;

FIG. 36C is a side view of the structure of FIG. 36B showing the frustoconical shape of the nesting roller;

FIG. 37 is an enlarged isometric view of the nesting stop of the present invention integrated into the structural frame;

FIG. 38 is an enlarged isometric view of the structural frame in isolation illustrating the mounting location of the nesting roller of the present invention;

FIG. 39 is an isometric view of an outside of the scuff plate of the present invention;

FIG. 40 is an isometric view of an inside of the scuff plate of FIG. 39;

FIG. 41 is an isometric view of the rear wall and its associated structures in isolation;

FIG. 42 is another isometric view of the structure of FIG. 41 taken at a different perspective;

FIG. 43 is a side view of the structure of FIG. 41;

FIG. 44 is a three-dimensional isometric view of another exemplary wheeled cart embodying the present invention;

FIG. 45 is another three-dimensional isometric view of the structure of FIG. 44 taken from a different perspective;

FIG. 46 is a top view of the structure of FIG. 44;

FIG. 47 is a side view of the structure of FIG. 44;

FIG. 48 is a rear view of the structure of FIG. 44; and

FIG. 49 is an enlarged view of the section 49-49 taken from FIG. 48 now showing the roller of the present invention.

### DETAILED DESCRIPTION OF EMBODIMENTS OF THE INVENTION

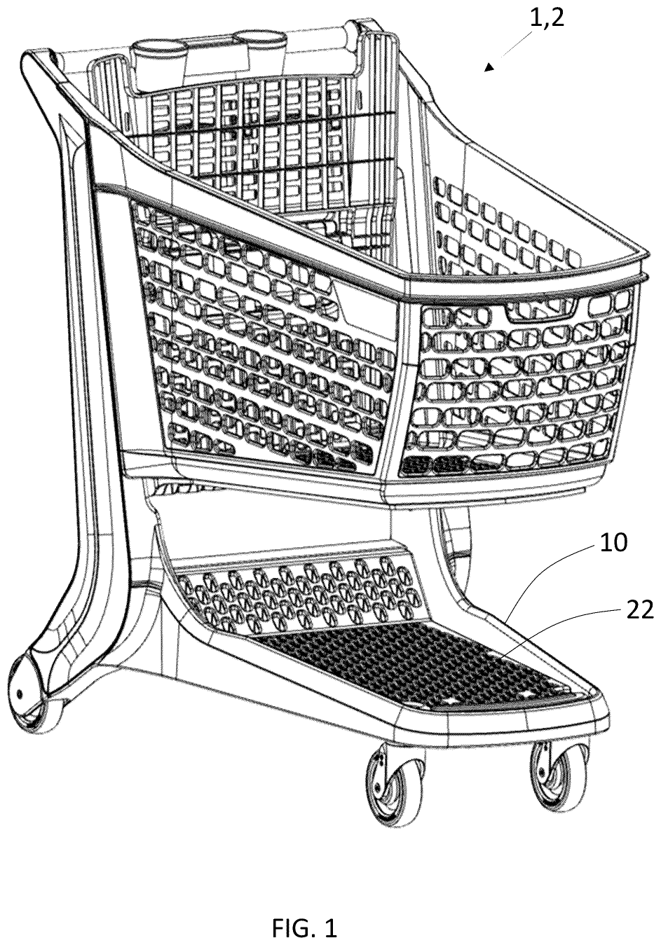

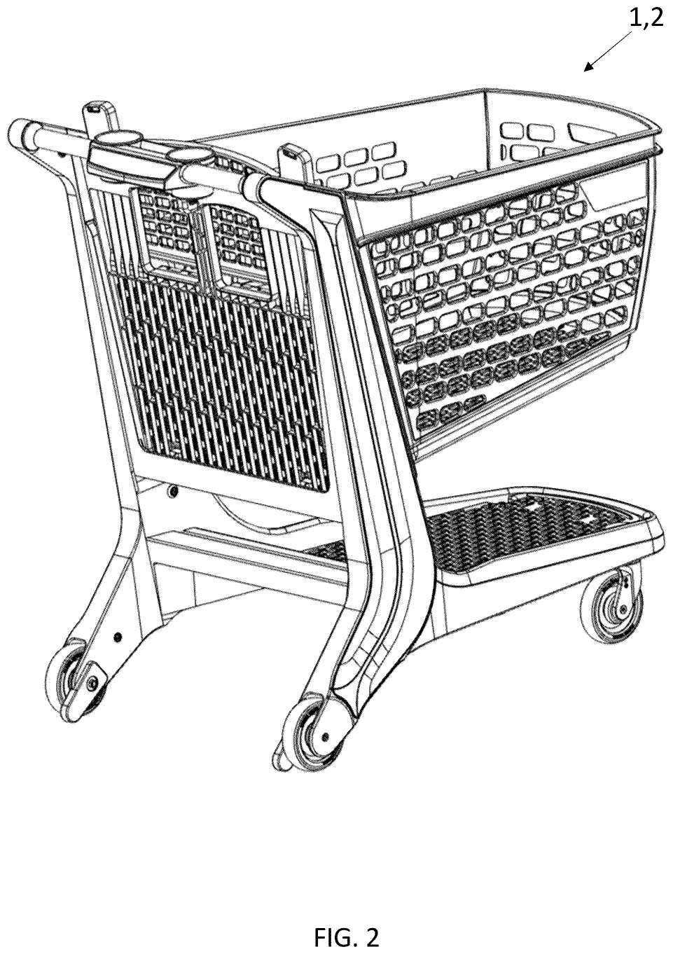

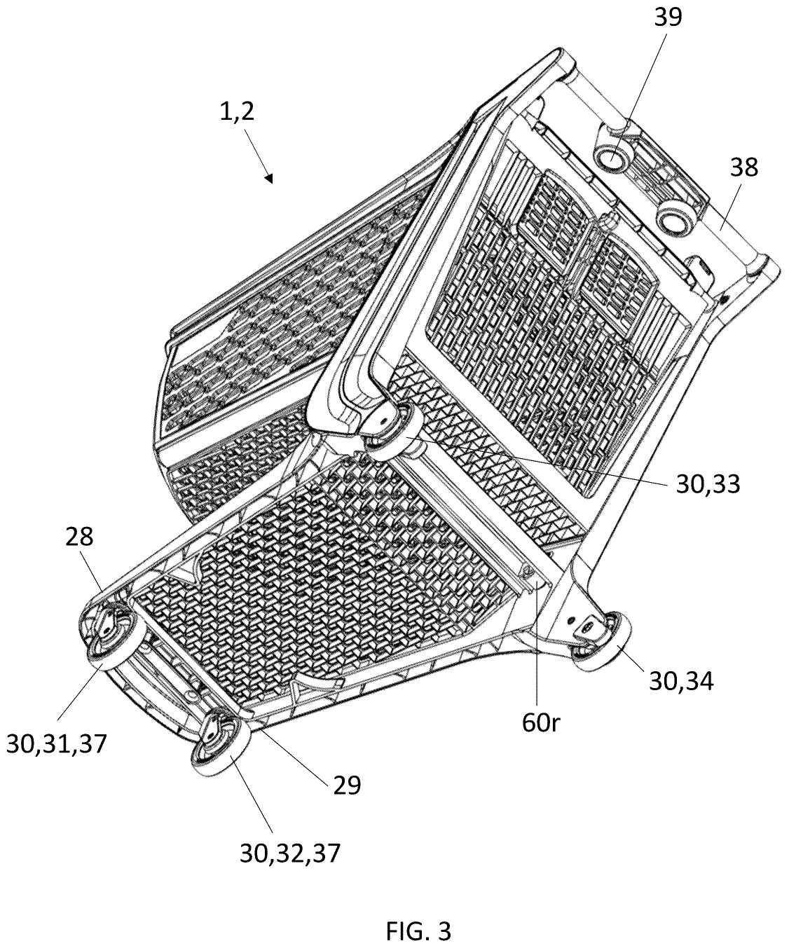

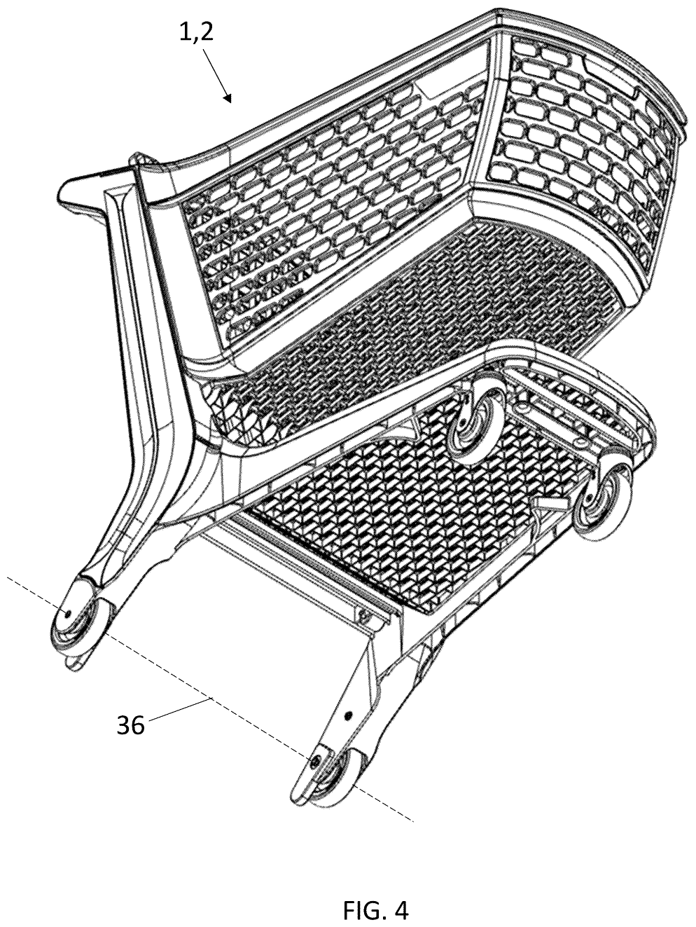

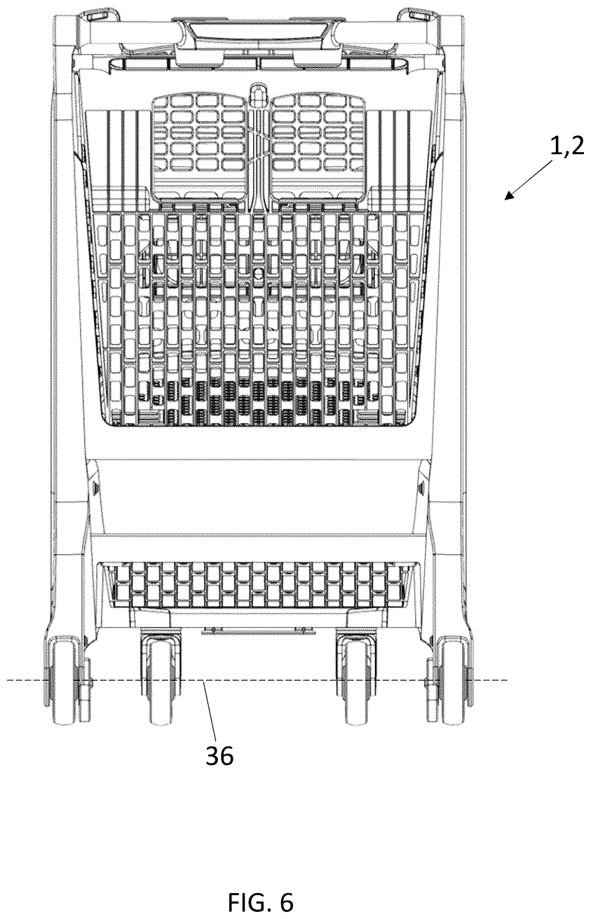

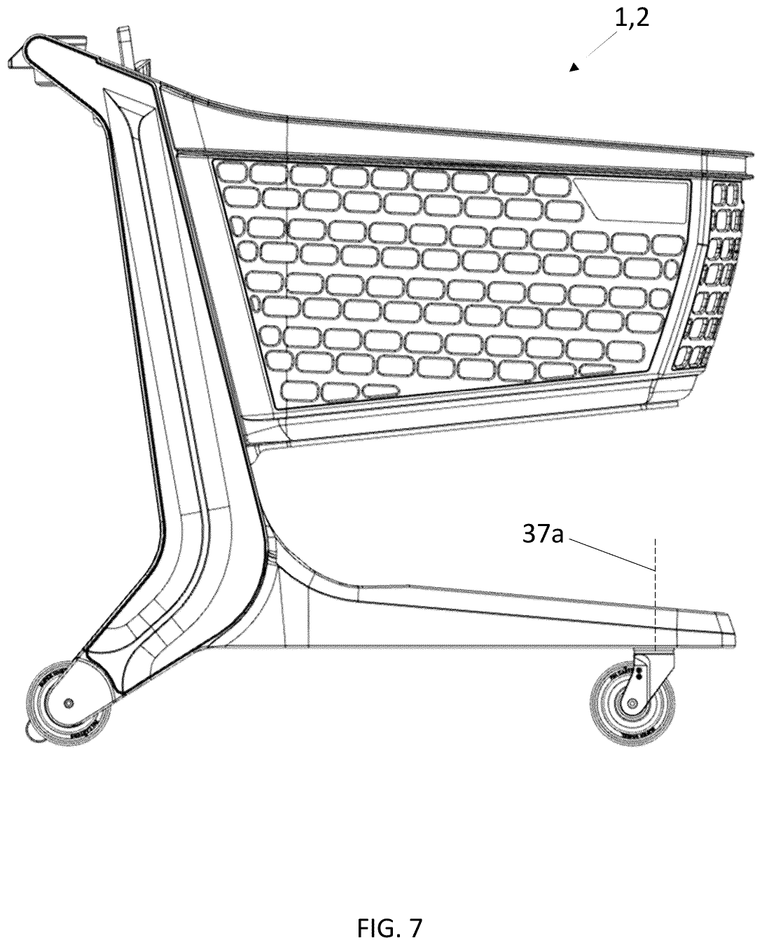

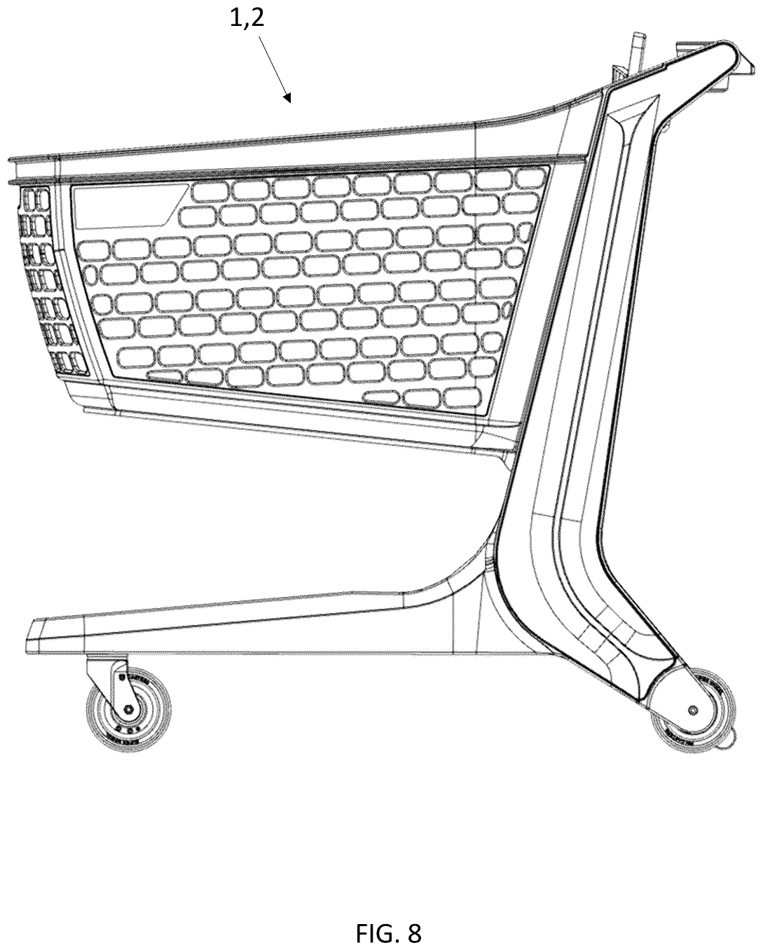

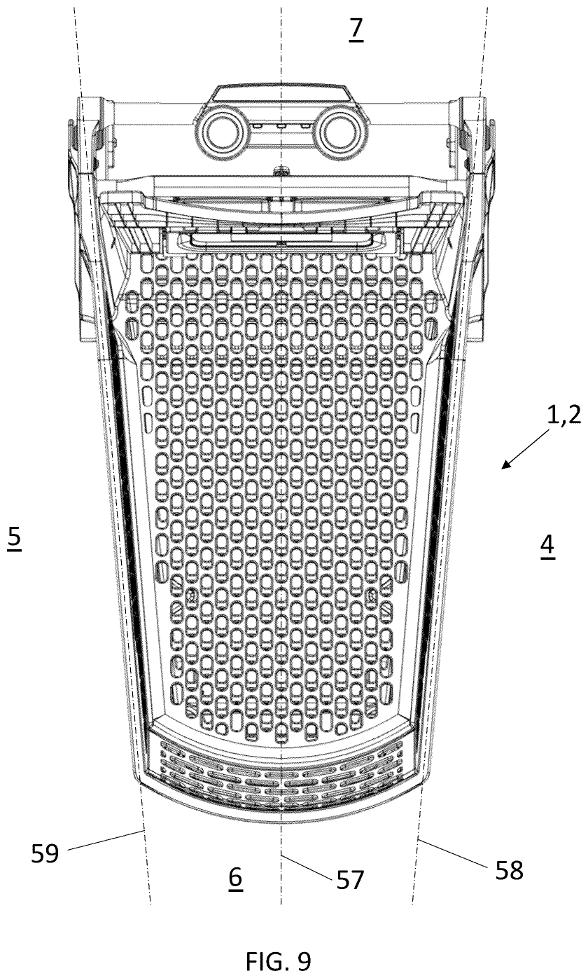

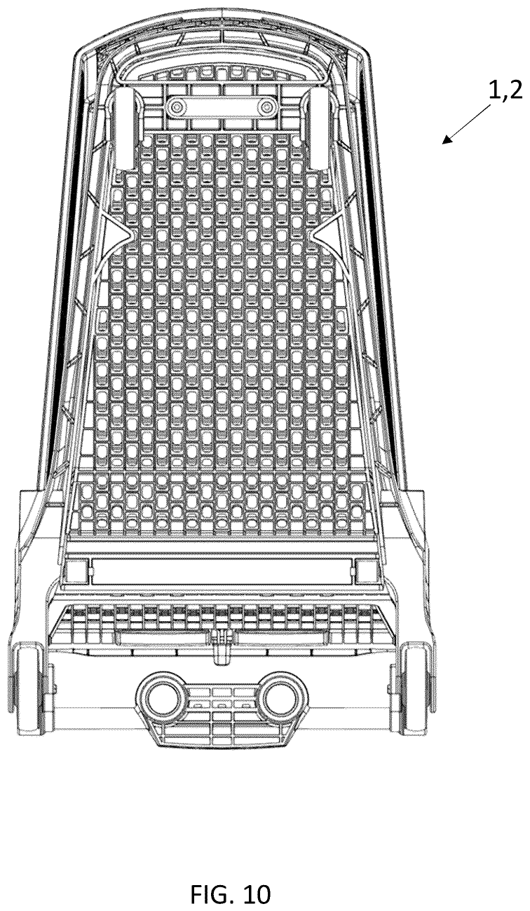

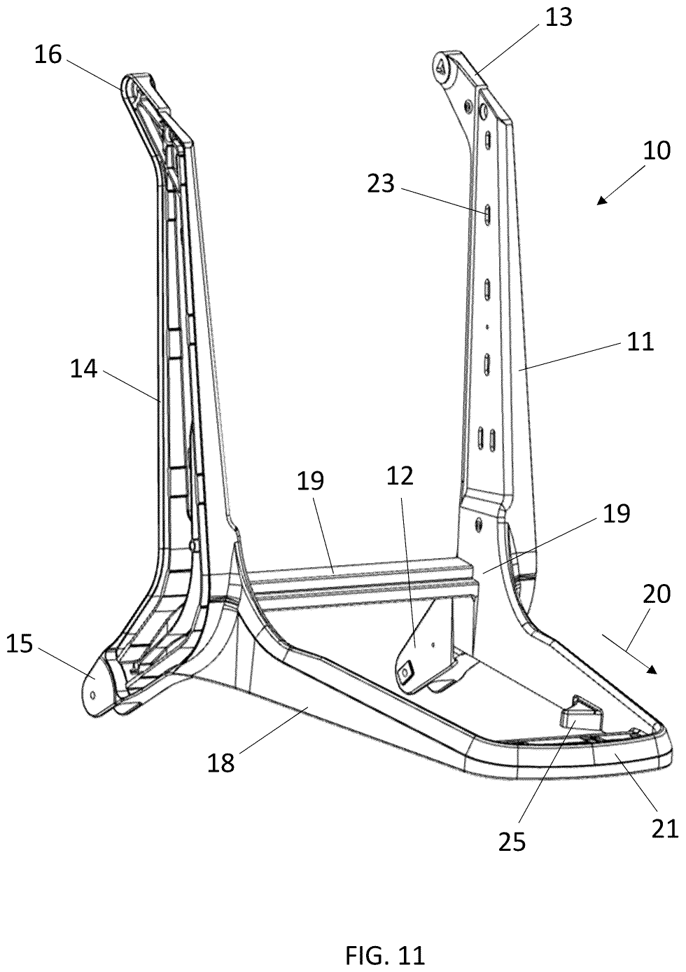

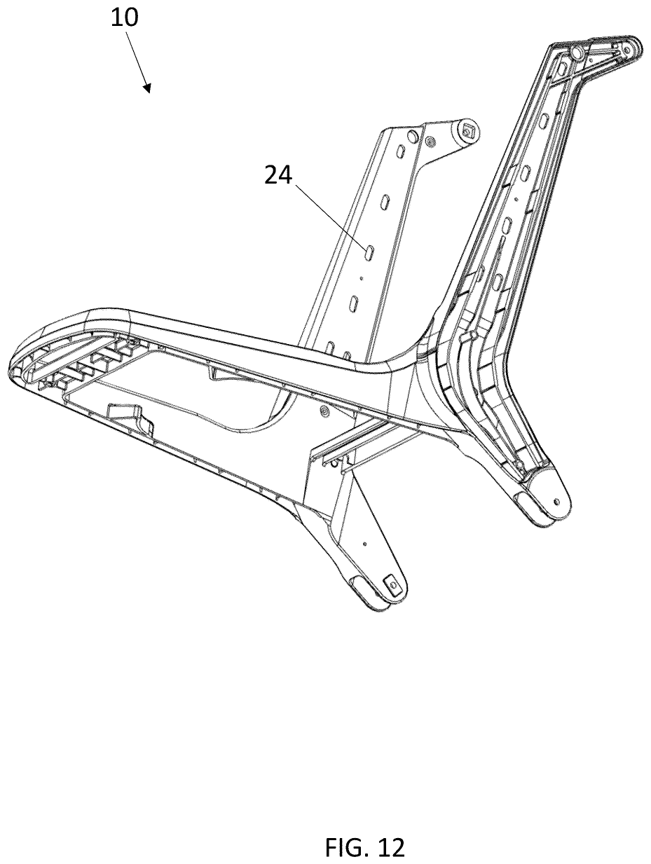

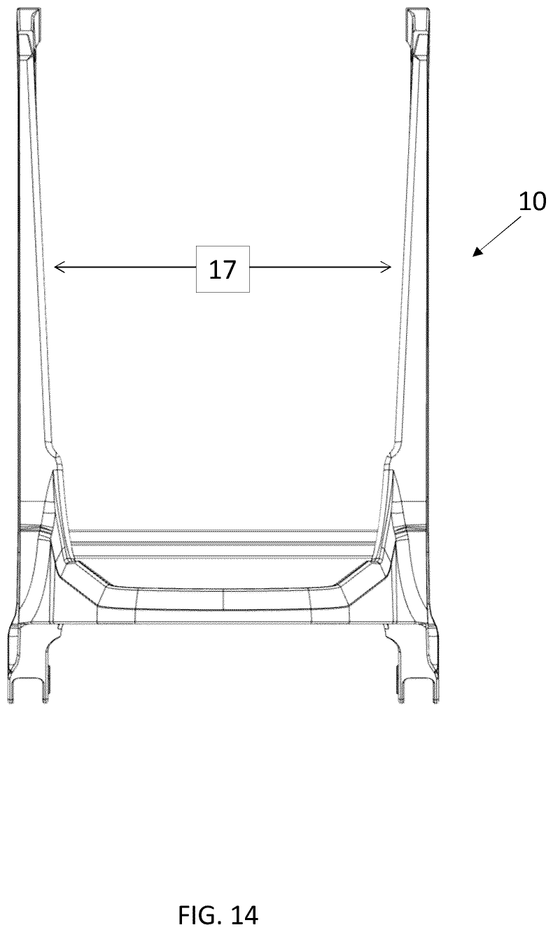

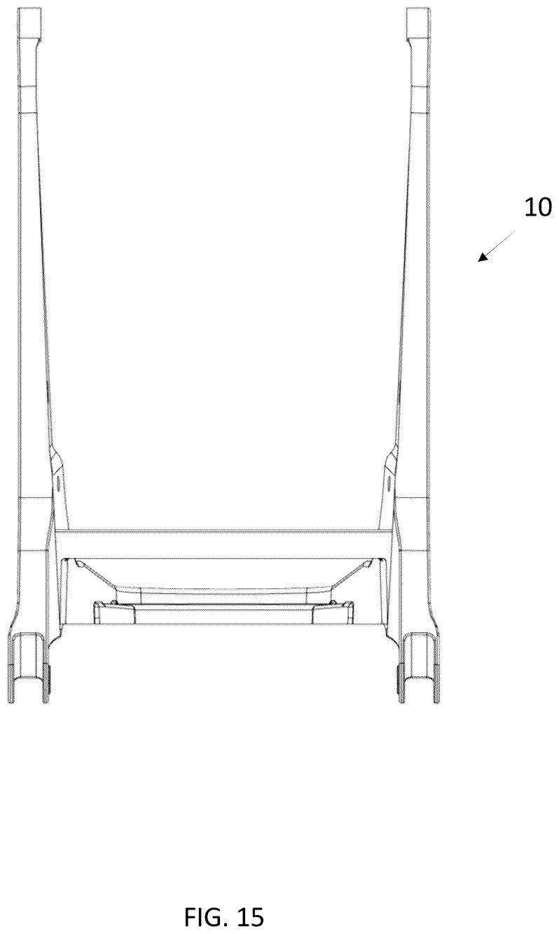

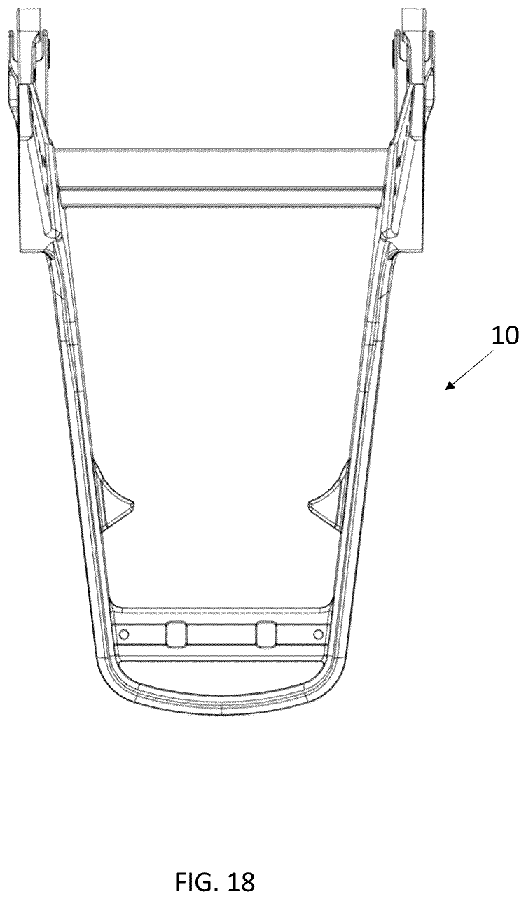

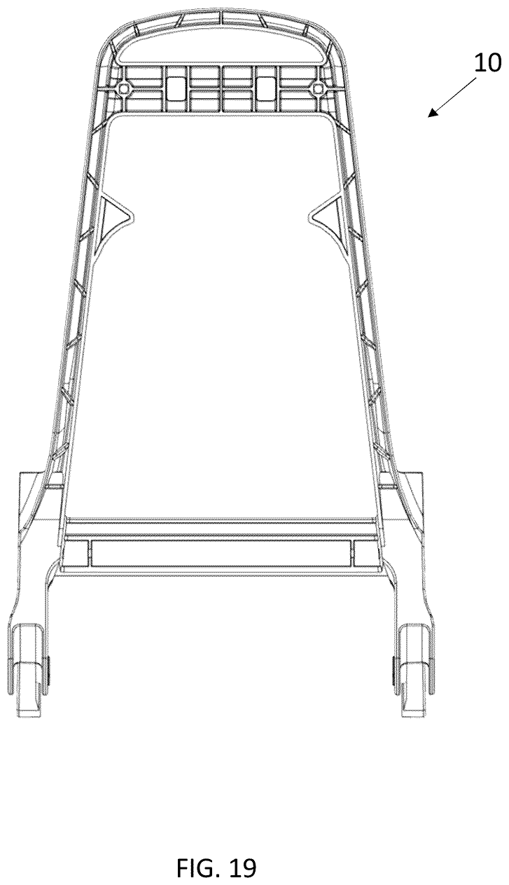

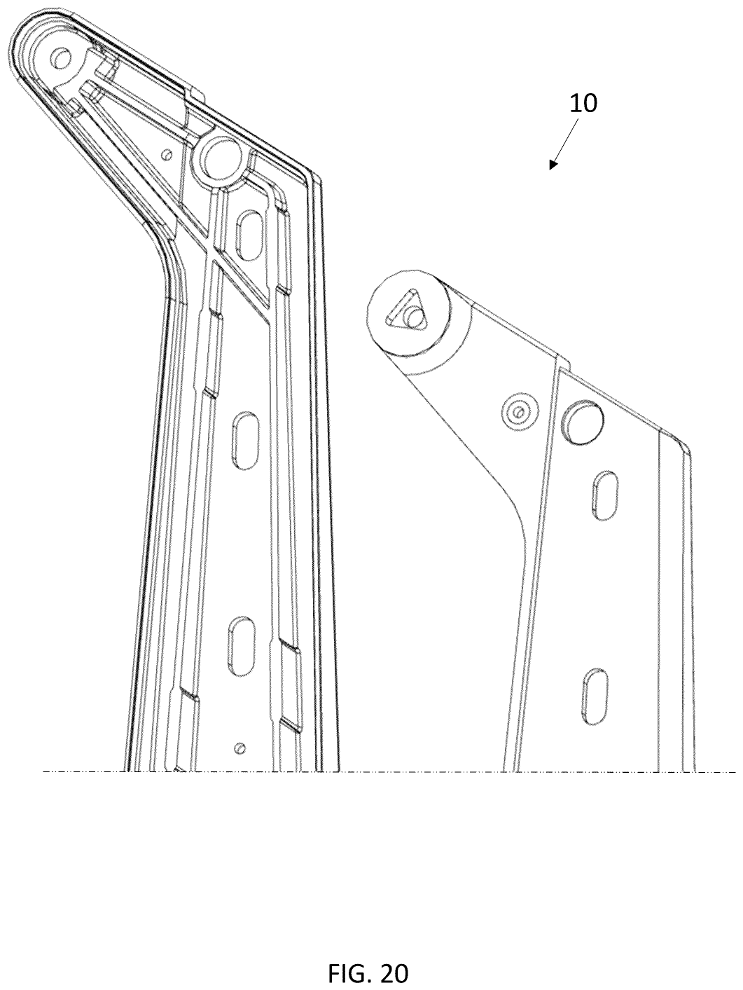

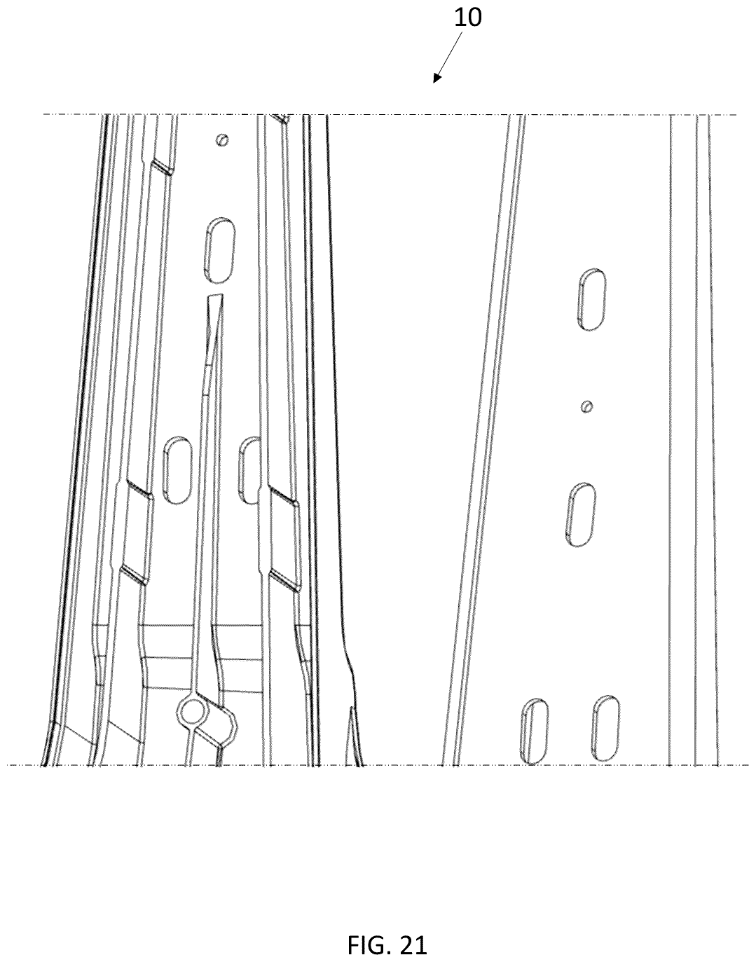

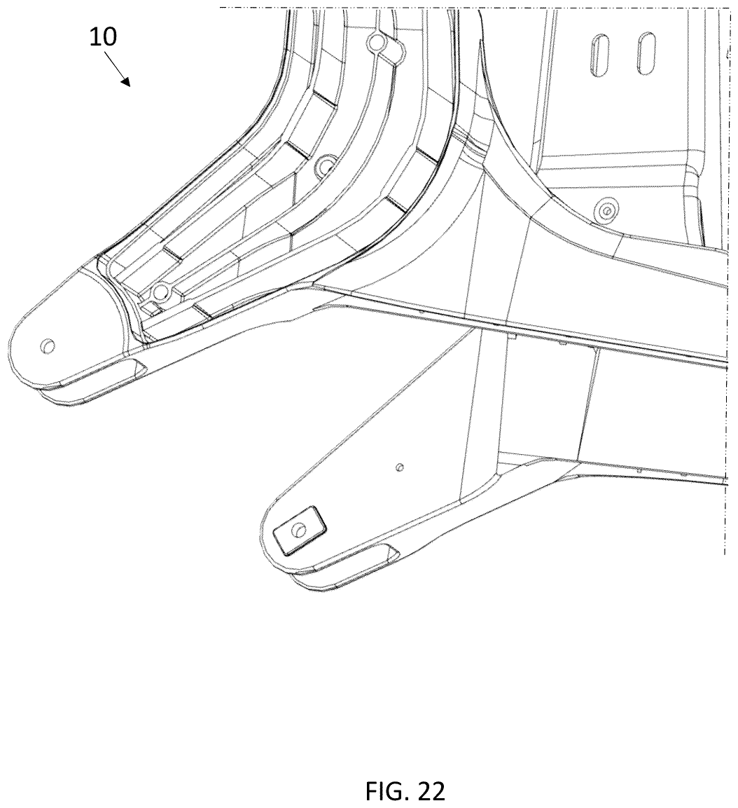

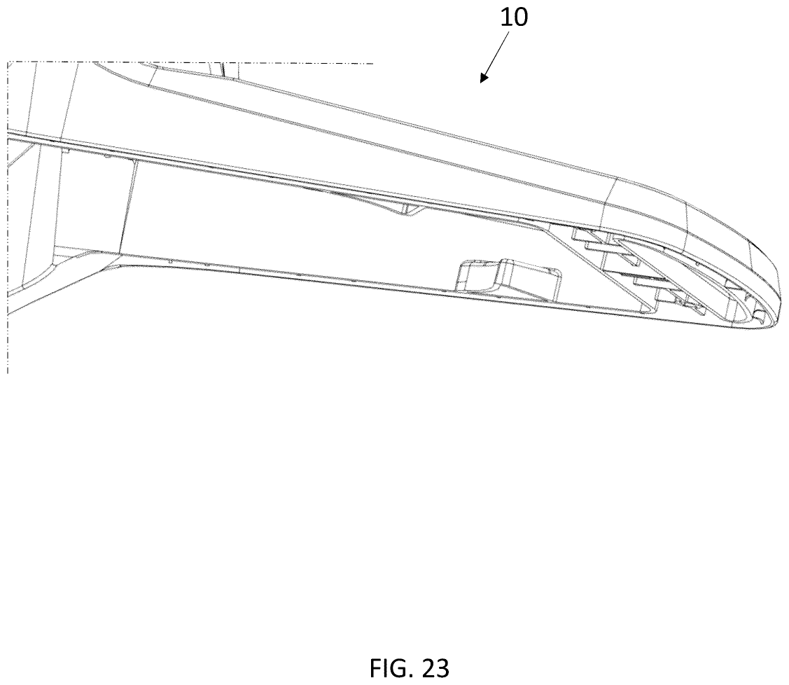

As shown in the drawings for purposes of illustration, the present invention for a wheeled cart is referred to generally by the reference number 1 and is best shown in FIGS. 1-10. The wheeled cart has a structural frame 10 that is best shown in FIGS. 11-23. Generally speaking, the wheeled cart has a left side 4, a right side 5, a front side 6 and a rear side 7.

The structural frame in this embodiment is a monolithic (i.e., single part) injection molded plastic part. Any material suitable for injection molding could be utilized to form the structural frame, such as ABS or polycarbonate, High-density polyethylene (HDPE), Long Glass Filled PP—50% LGFPP, Glass Filled Nylon, or any other material. The structural frame could also be made of other materials, such as fiberglass, metal, carbon fiber, composites or combinations thereof. The structural frame could even be 3D printed using polymers. However, it is expected that the structural frame would be made in an injection molding operation as once a mold has been designed, producing each additional structural frame requires little time and cost.

The structural frame includes a left vertical support 11 extending at least vertically from a bottom left end 12 to a top left end 13. Likewise, a right vertical support 14 extends at least vertically from a bottom right end 15 to a top right end 16. The left vertical support is disposed a frame width 17 apart from the right vertical support. A bottom horizontal support 18 is connected to and/or disposed between the left and the right vertical supports and may include a rear end cross brace 19 connecting the bottom ends of the left and right vertical supports. The rear end cross brace 19 helps provide stability to the structural frame that prevents twisting and bending of the frame. It is noted that the top ends of the vertical supports are not connected but will be connected to the handle and basket as later discussed which then adds more structural rigidity to the wheeled cart. The bottom horizontal support extends at least horizontally in a forward direction 20 from the rear end to a front end 21 of the bottom horizontal support, such that the wheels, which in some embodiments are casters, can be attached to the bottom horizontal support forming the wheeled cart. The bottom horizontal support has a U-shape when viewed from a top view. It is also understood to those skilled in the art that the rear end cross brace could be attached anywhere between the vertical supports and/or the bottom horizontal support.

The bottom horizontal support is configured to carry and/or support a lower shelf 22. The lower shelf is configured to retain an item placed on the lower shelf by a user (i.e., customer). In this embodiment the lower shelf is separately manufactured and attached to the bottom horizontal support. Alternatively, and not shown, the lower shelf may be integrally formed as part of the monolithic injection molded structural frame. Having the lower shelf configured as a separate part that can be attached and removed allows different variations of the lower shelf to be used with the same structural frame. This allows the structural frame to become a universal frame that accepts a wide variety of lower shelf designs and configurations that may be customized for a particular retailer.

The left vertical support includes a plurality of left frame fixturing holes 23 and similarly the right vertical support includes a plurality of right frame fixturing holes 24. The fixturing holes 23 and 24 will be used to attach the basket as later discussed. In this embodiment the fixturing holes are slots which slots allow a bit more leeway during assembly of the wheeled cart. The structural frame also includes at least one nesting stop 25 extending inwardly from the bottom horizontal support. The at least one nesting stop is configured to abut the front end of a similarly designed second wheeled cart 2 when the second wheeled cart is nested within the first wheeled cart. The at least one nesting stop comprises a left-side nesting stop 26 and a right-side nesting stop 27. The left-side nesting stop is configured to abut a left-side front end 28 of the second wheeled cart and the right-side nesting stop is configured to abut a right-side front end 29 of the second wheeled cart.

A plurality of wheels 30 are rotatably attached to the structural frame. The plurality of wheels includes a left front wheel 31, a right front wheel 32, a left rear wheel 33 and a right rear wheel 34. Each wheel is rotatably attached to the structural frame and configured to roll upon a horizontal surface 35 in unison, the horizontal surface being a common ground plane 35. In preferred embodiments, the front wheels are attached to swivel forks which are, in turn, attached to the frame—the entire assembly is commonly referred to as a caster. All of the wheels (and casters) attach directly to the structural frame. The left rear wheel is rotatably attached to the structural frame at or near the bottom left end. The right rear wheel is rotatably attached to the structural frame at or near the bottom right end. The left rear wheel and the right rear wheel are aligned along a common rear axis 36 and comprise rigid casters, meaning they do not rotate about a vertical axis. The common rear axis is not physically connected between the left and right rear wheels but rather is aligned in configuration. Alignment is not necessary but is preferred for symmetry. The left front wheel is rotatably attached to the structural frame at or near the left-side front end of the bottom horizontal support. Similarly, the right front wheel is rotatably attached to the structural frame at or near the right-side front end of the bottom horizontal support. The left front wheel and the right front wheels comprise swivel casters 37, meaning that they rotate about axes 37a and 37b, such that they can turn and allow the cart to pivot. The axes 37a and 37b are disposed perpendicular to one another with the axis 37b being disposed a distance apart from where axis 37a would pass through. In other words, axis 37a is a vertical axis and axis 37b is a horizontal axis where the horizontal axis does not pass through the vertical axis. This means the wheel follows where the cart is be being pushed, or as aptly described, it swivels so that the wheel is in line with direction of travel.

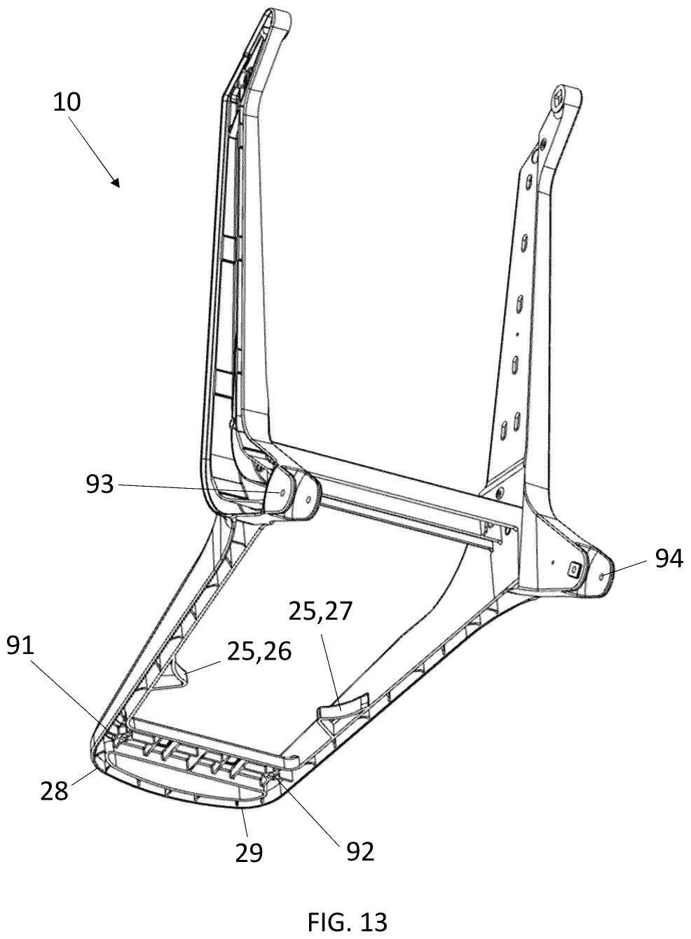

The wheels are connected directly to the structural frame. Accordingly, at least one left front wheel fixturing hole 91 is disposed through the structural frame located at or near the left-side front end as best seen in FIG. 13. Similarly, at least one right front wheel fixturing hole 92 is disposed through the structural frame located at or near the right-side front end. In these embodiments there is a single through hole for the front wheel swivel casters to attach to, but those skilled in the art understand that a plurality of holes or receptacles could have been configured to allow attachment of the front wheel swivel casters. Regarding the rear wheels, at least one left rear wheel fixturing hole 93 is disposed through the structural frame located at or near the bottom left end of the left vertical support and at least one right rear wheel fixturing hole 94 is disposed through the structural frame located at or near the bottom right end of the right vertical support. Here, there are actually two holes for each side, as then the rigid casters (i.e., not swivel casters) can be attached with a bolt and a nut.

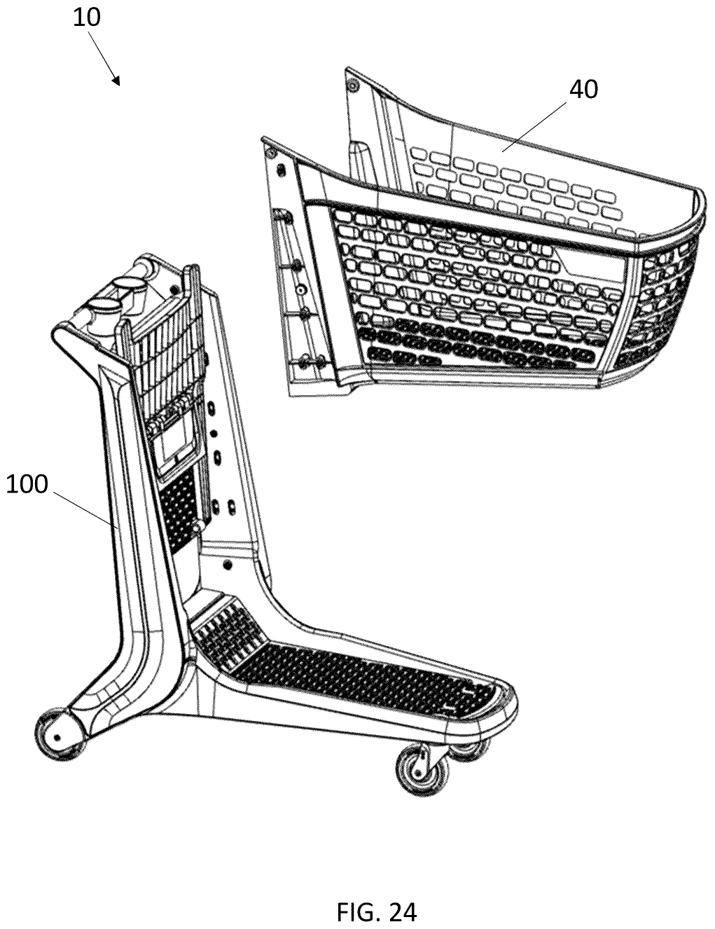

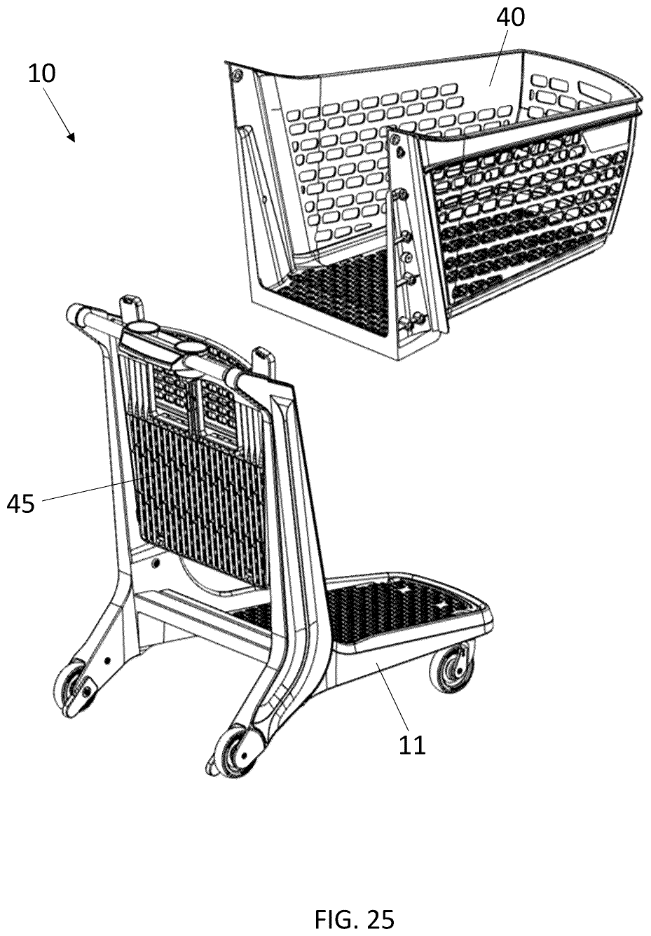

As best shown in FIGS. 24-26, a basket 40 is configured to be disposed within the width and attach to the structural frame. The basket includes a basket floor 41 extending at least horizontally (it is actually sloped upwardly) and connected to a left-side wall 42, a front wall 43, a right-side wall 44. When the wheeled cart is assembled, the basket also includes a rear wall 45 that is pivotably attached, which when pivotally attached, may also be referred to as a gate. The left-side wall, the front wall and the right-side wall each extend at least vertically where a top 46 of the basket is open. It is understood that when in use by a customer the basket is configured to retain the item placed upon the basket floor. As mentioned, the rear wall is pivotably attached to the left-side wall and the right-side wall or to the left vertical support and the right vertical support at or near the top of the basket. Here, the rear wall is pivotably attached to the left and right vertical supports through the use of a fastener 83 (i.e., shoulder screw) as is later discussed herein for the roller. It is a simplification of assembly and to reduce part counts to use the same fastener for both rotatably attaching the rear wall and the nesting roller.

The basket is a separately manufactured part in comparison to the structural frame. By separately manufacturing the basket from the structural frame, a universal frame has been achieved that can accept a wide variety of basket designs. This allows a simplification of the manufacturing process as one frame can be used with a wide variety of basket designs customized per each retail store's needs. In the embodiments shown herein the left-side wall, the front wall, the right-side wall and the basket floor are a monolithic (i.e., single part) injection molded plastic part. As with the structural frame, the basket can be manufactured using similar materials or manufacturing methods.

To facilitate the nesting of the wheeled carts, the basket floor is angled upwards in relation to the common ground plane extending from the rear wall towards the front wall. The left-side wall is angled inwards towards a centerline 57 of the basket extending from the rear wall towards the front wall in a left plane 58 that is perpendicular to the common ground plane. Likewise, the right-side wall is angled inwards towards the centerline of the basket extending from the rear wall towards the front wall in a right plane 59 that is perpendicular to the common ground plane. The angling of the basket floor and side walls allows a similar shaped cart to nest the baskets within each other when the rear wall pivots upward. This nesting of wheeled carts is well known to those skilled in the art and need not be further discussed herein.

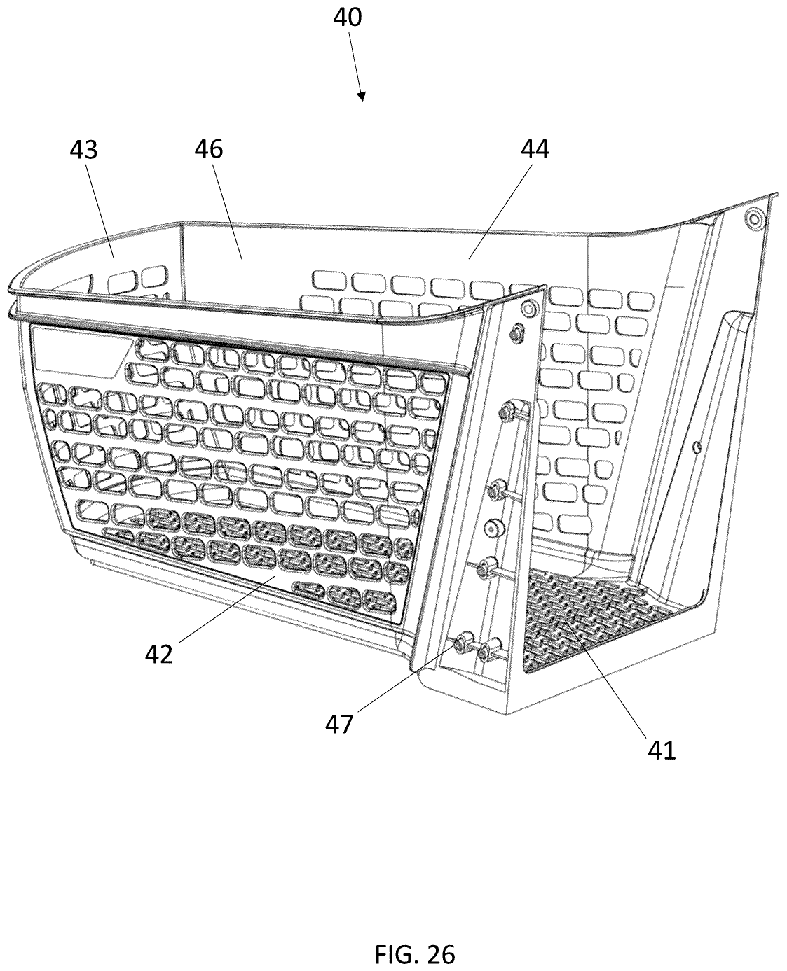

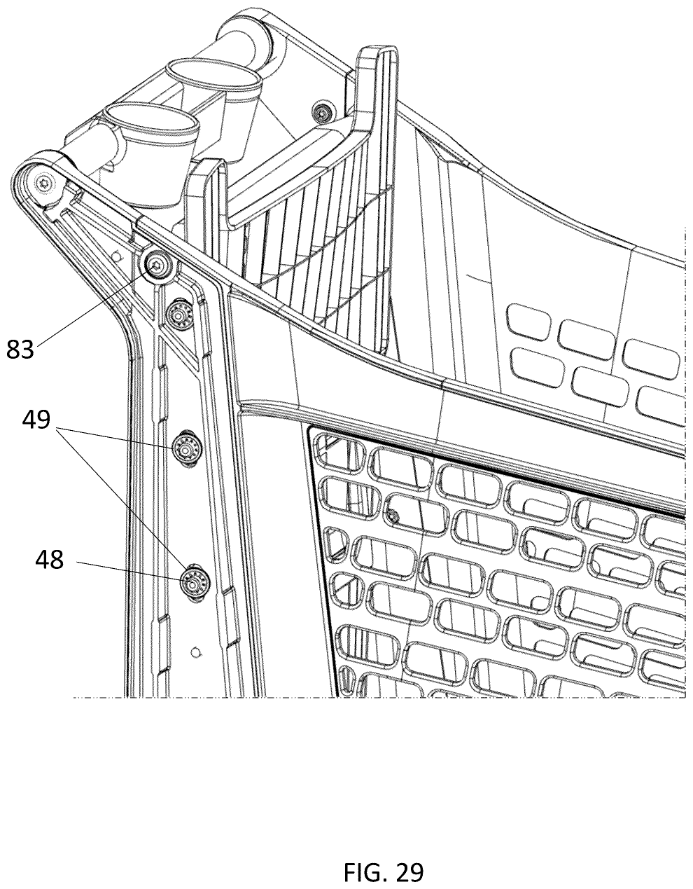

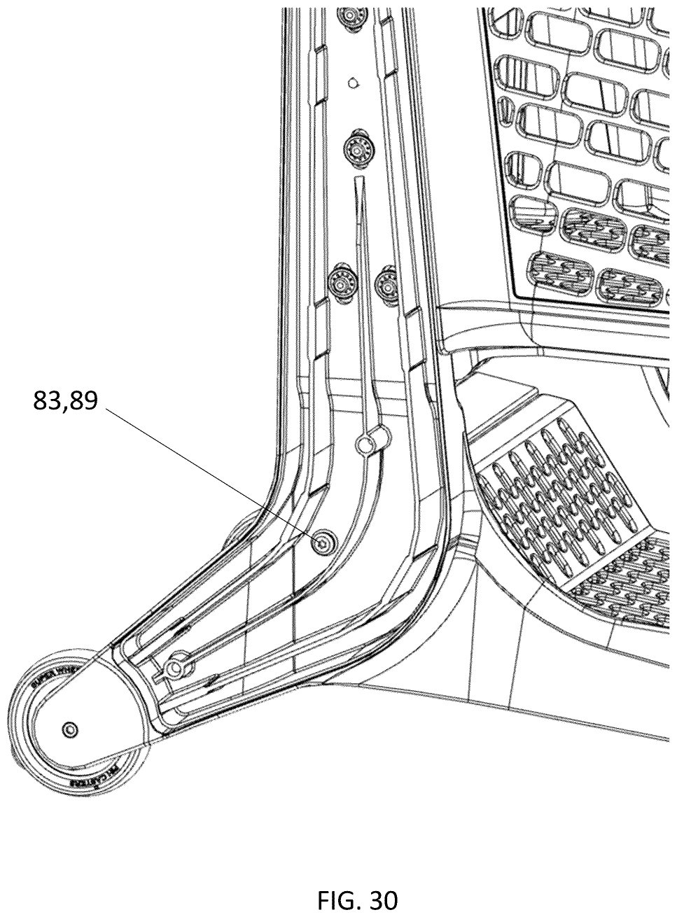

As best seen in FIG. 26, the left-side wall includes a plurality of left-side wall studs 47 extending outwardly and configured to match the spacing of the plurality of left frame fixturing holes and extend therethrough. Here, there are six studs 47 extending outwardly. It is understood by those skilled in the art that any number of studs could have been used such that this teaching is not to be limited to the precise form shown herein. Similarly, the right-side wall includes a plurality of right-side wall studs 48 extending outwardly and configured to match the spacing of the plurality of right frame fixturing holes and extend therethrough. As best seen in FIGS. 29-30 a plurality of fasteners 49 secure the basket to the structural frame by engaging the plurality of wall studs extending through the plurality of fixturing holes. In this embodiment, the plurality of fasteners comprise spring push nuts (alternatively push-on external retaining rings, push-on retaining caps, rectangular push-on external retaining rings, flanged push-on external retaining rings, size-mount external retaining rings, round push nuts, rectangular push nuts, flanged push nuts, speed nuts), as spring push nuts eliminate the need for auxiliary tooling for attachment. It is also possible that screws, bolts, nuts and other fasteners could have been used to attach the basket to the structural frame.

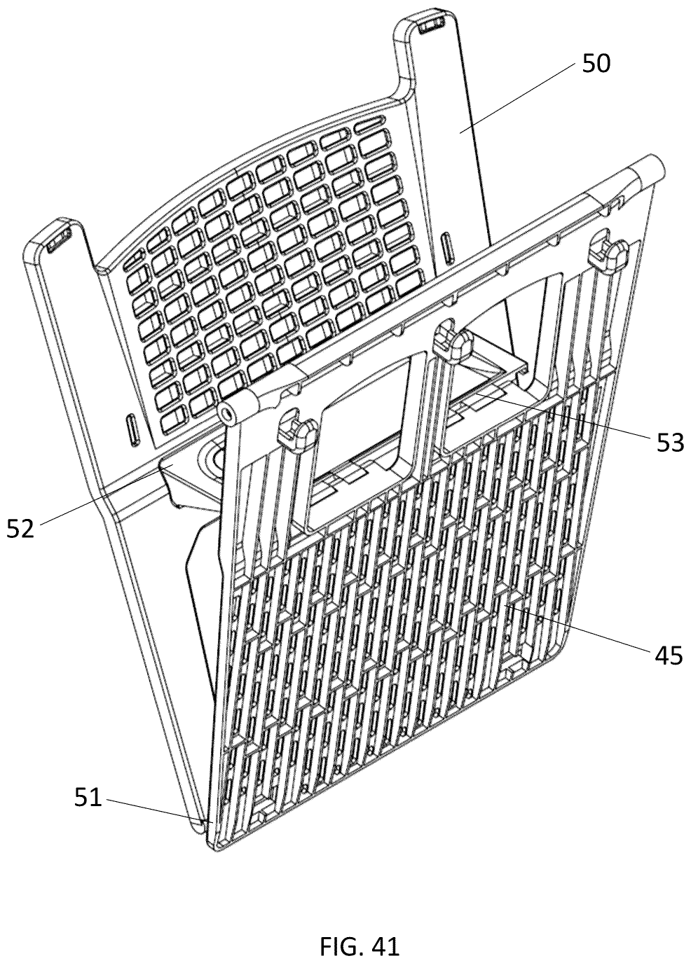

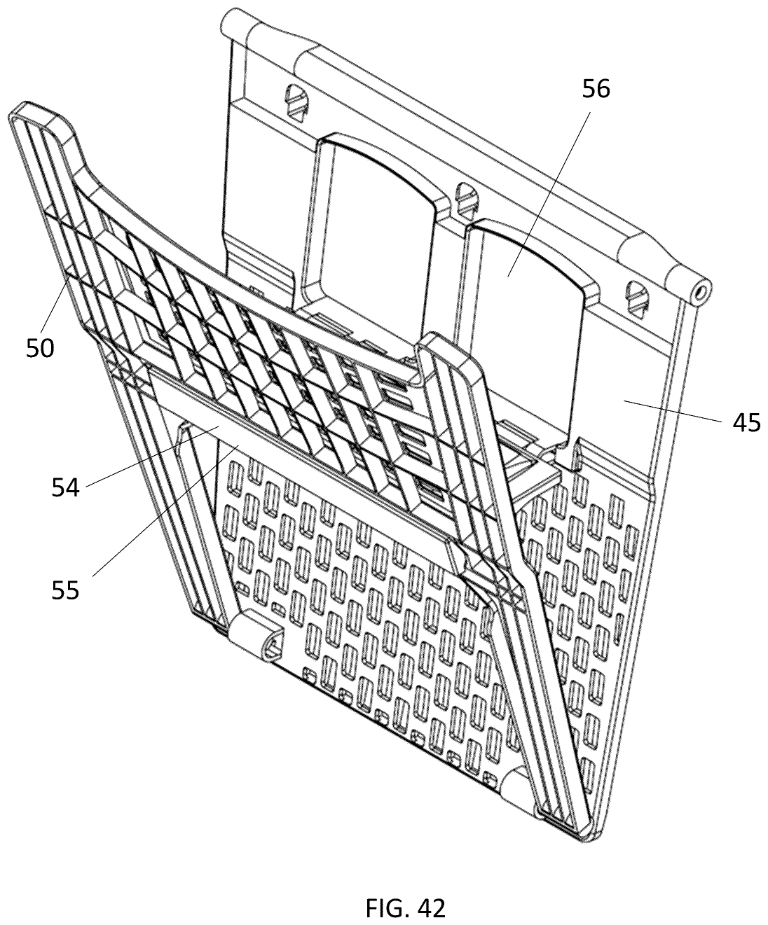

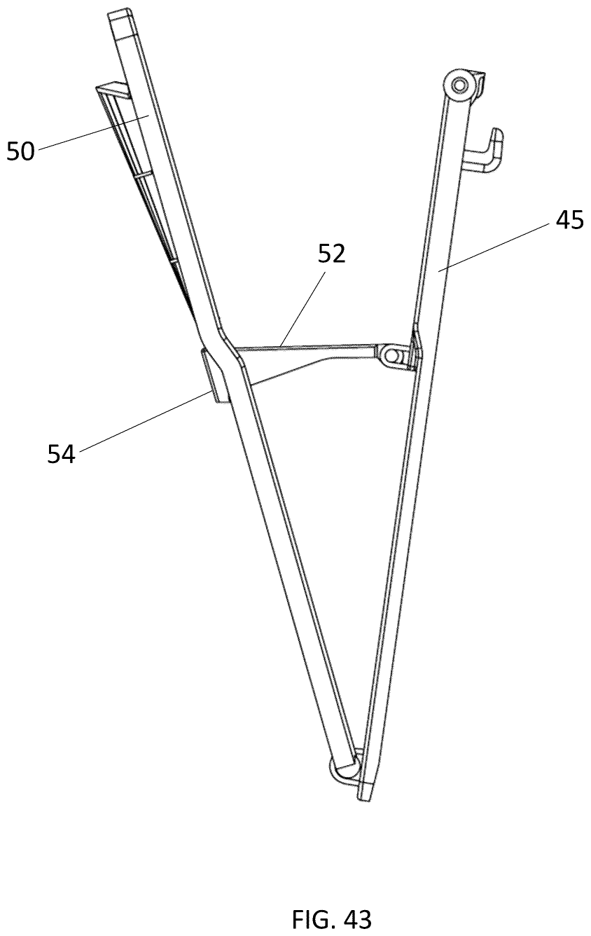

As best seen in FIGS. 41-43, the rear wall gate assembly includes a secondary rear wall backrest 50 pivotably connected to the rear wall at a bottom 51 of the rear wall. The secondary rear wall is configured to pivotably open towards an inside of the basket. Furthermore, an intermediate platform or seat 52 is pivotably connected to the rear wall at a proximal end 53 and having an engagement feature 54 at a distal end 55. The engagement feature is configured to engage the secondary rear wall in horizontal position. The rear wall or gate includes at least one aperture 56, such that a child can sit upon the intermediate platform with a child's legs disposed through the at least one aperture.

A handle 38 is horizontally disposed extending between the top left end and the top right end of the structural frame. The handle is configured to be engaged by the user (i.e., customer) of the wheeled cart. In the embodiments shown herein the handle has at least one cup holder 39. The cup holder, or smart phone holder, may be integrated into the design of the handle or may be a separately manufactured part that is attached to the handle.

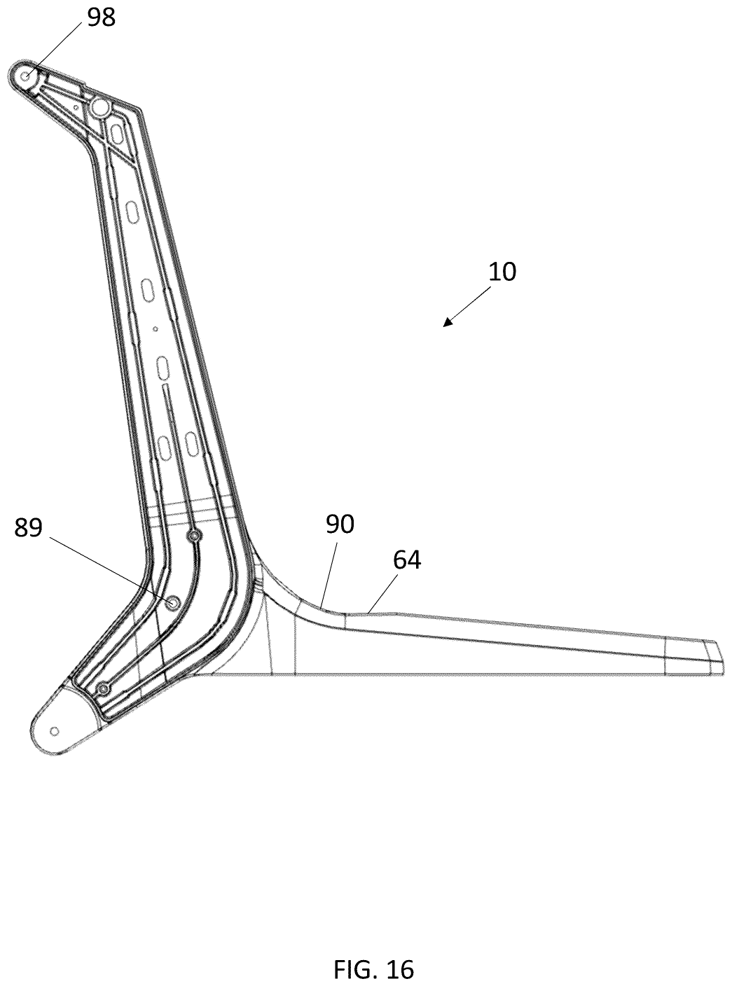

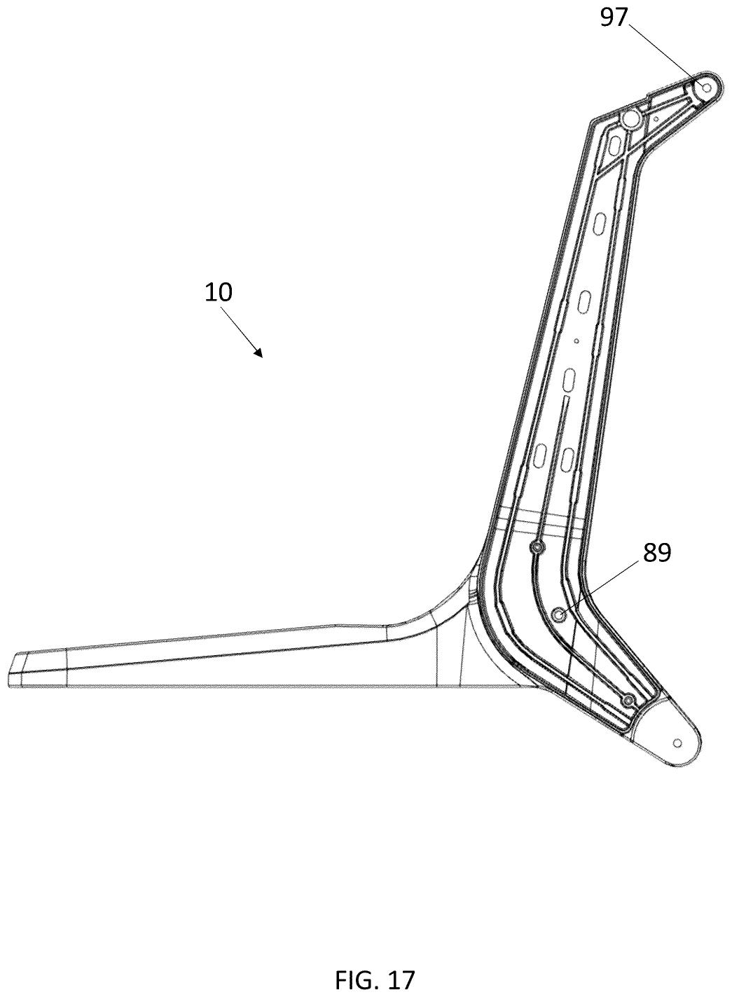

The structural frame is also configured to receive the handle, as installation of the handle helps stiffen the structural frame. Accordingly, a left-side handle fixturing hole 97 is disposed at or near the top left end of the left vertical support and a right-side handle fixturing hole 98 disposed at or near the top right end of the right vertical support as best seen in FIGS. 16 and 17. Typically a fastener would be used to screw into the handle from an outside of the vertical supports to fixedly secure the handle to the vertical supports.

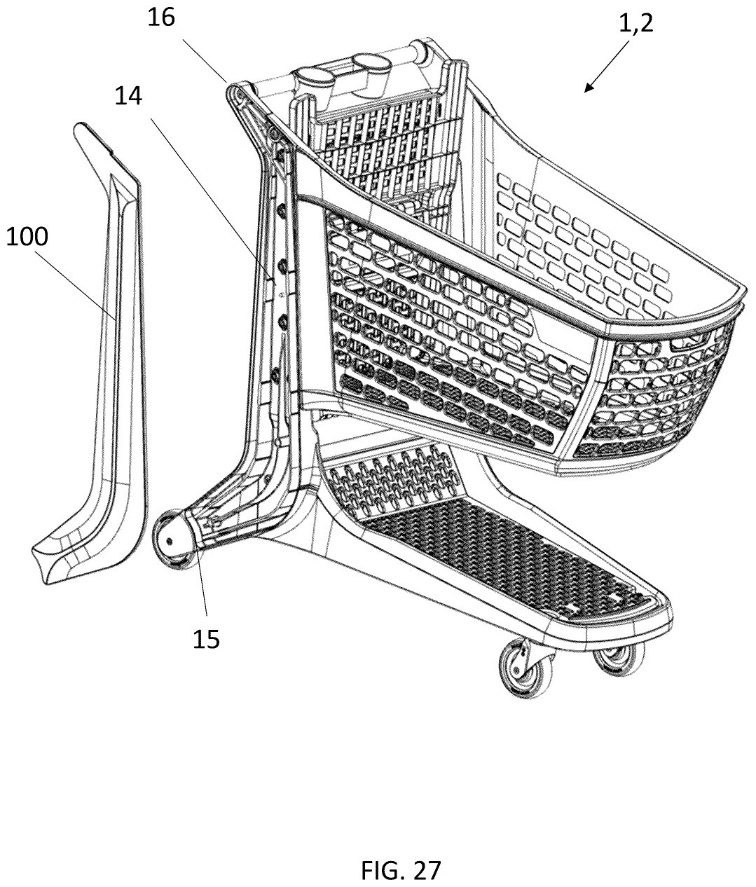

FIGS. 27, 39 and 40 show a removable scuff plate 100 that can be attached and removed on both sides of the wheeled cart 1. Although the application herein refers to scuff plate 100 in the singular, it should be appreciated that such reference could be referring to a left scuff plate, right scuff plate or both. It is also understood herein the removable scuff plate may be similarly referred to as a sacrificial wear panel, as the scuff plate may be removed and replaced in a sacrificial manner.

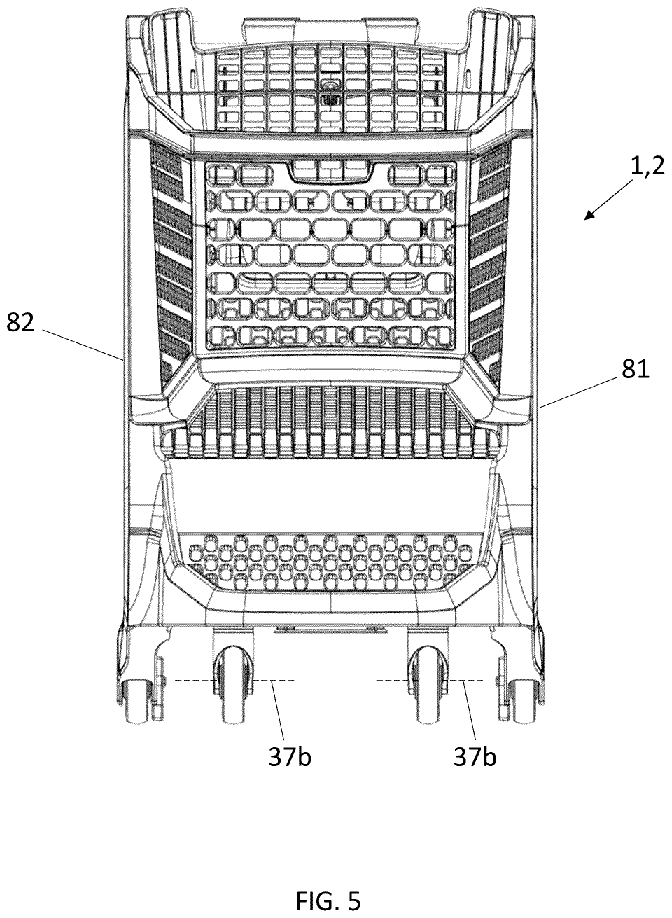

Looking at FIGS. 11 and 27, the scuff plate 100 is removably coupled to the structural frame 10 at the left vertical support 11 and right vertical support 14. As shown in FIG. 5, the scuff plate 100 is designed to extend the left vertical support 11 and right vertical support 14 to create a left outermost point 81 and right outermost point 82. Accordingly, the scuff plate 100 on the right-side and left-side become the widest most points of the wheeled cart 1.

It should be appreciated that the scuff plates 100 not only create the widest point on each side of the wheeled cart 1 but define the widest point on each side of the wheeled cart 100 over the entire height of the wheeled cart 100. As may be appreciated, the scuff plates 100 may define a widest line that extends along the vertical height of the wheeled cart or even a widest plane on each side of the wheeled cart 100.

In preferred embodiments, the scuff plates 100 define a widest point for the wheeled cart 100 at least over the entire height of the basket 40. In an even more preferred embodiment, the scuff plates 100 define a widest point for the wheeled cart 100 from at least the top of the basket 40 to a bottom of the bottom shelf/platform 22. In yet other embodiments, the scuff plates 100 define the widest point of the wheeled cart 100 from the top of the handle to the top of the wheels. In still yet other embodiments, the scuff plates define a widest point of the wheeled cart 1 over the entire vertical height of the wheeled cart 1.

Because the scuff plates 100 on the right and left-side of the wheeled cart 1 are the two widest points of the wheeled cart 1, it becomes highly likely that when a customer bumps the cart, the impact is received at the scuff plate 100. It is very common for customers pushing shopping carts to underestimate the width of a shopping cart and try and push the cart through a gap that is too narrow for the cart. In such an occurrence, one or more of the scuff plates would take the impact and protect the structural frame 100 of the cart. Because the scuff plates are removably coupled to the wheeled cart 1, they can be easily replaced if they become damaged. Moreover, scuff plates 100 are designed to be much cheaper to manufacture than one or more portions of the structural frame 10 such that limiting damage to the scuff plates 100 helps make repair of the wheeled cart 1 much more economical.

Returning to FIG. 27, in preferred embodiments, the shape of the each of the scuff plates 100 exactly matches the outer profile of the right vertical support 14 and although not shown, the left vertical support 11. Completely covering the left vertical support 11 and right vertical support 14 with respective scuff plates 100, ensures that the structural frame in those areas is protected by the scuff plates.

In the embodiment shown in FIG. 27, the scuff plate 100 covers the entire width of right vertical support 14 and likewise, left vertical support 11 (not shown). In other embodiments, the scuff plate 100 may not extend over the entire width of the vertical support but when assembled, always remains the widest point on the wheeled cart 1.

In the embodiments shown in FIG. 27, the scuff plate 100 on the right-side of wheeled cart 1 extends vertically over the right vertical support 14 from the bottom right end 15 to a top right end 16. Likewise, a scuff plate 100 on the left-side of wheeled cart 1 extends over the left vertical support 11 at least vertically from the bottom left end 12 to the top right end 13.

As may be appreciated from FIG. 27, a small portion of the right vertical support 14 surrounding the left rear wheel is not covered. However, it may be appreciated that this uncovered area surrounding the left rear wheel in inset from the ultimate width of the wheeled cart 1 such that it is unlikely to get contacted when the scuff plate 100 is assembled.

In general, the right scuff plate covers 75% or more of the surface area of the outermost side of the right vertical support 14. In more preferred embodiments, the right scuff plate covers 90% or more of the surface area of the outermost side of the right vertical support 14. In even more preferred embodiments, the right scuff plate covers 95% or more of the surface area of the outermost side of the right vertical support 14. In some embodiments, the right scuff plate covers 100% of the surface area of the outermost side of the right vertical support 14.

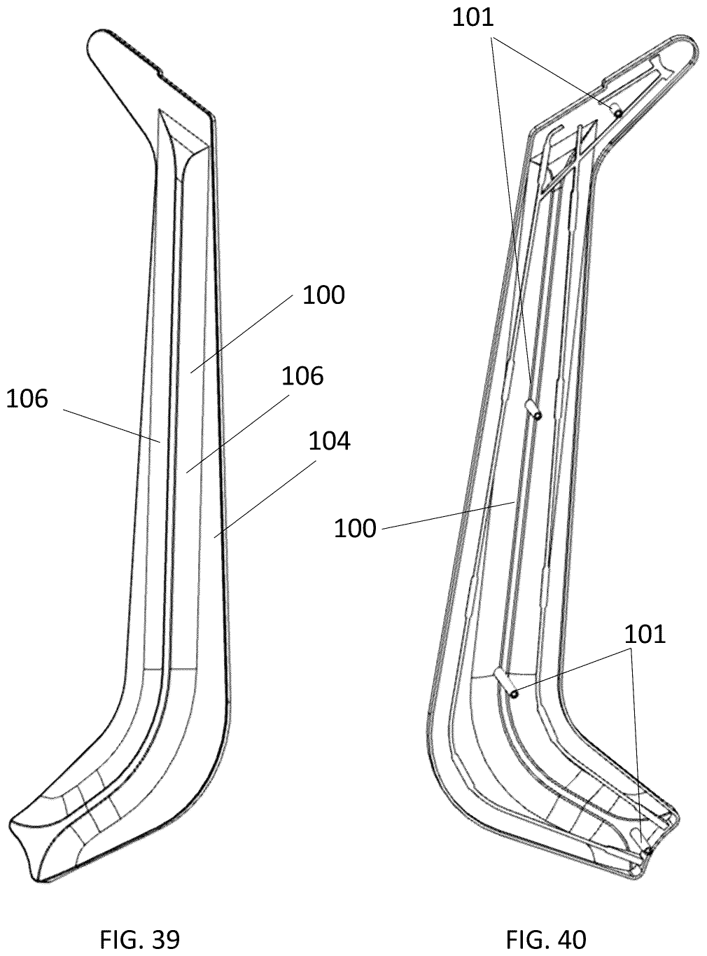

Returning to FIGS. 39 and 40, both sides of scuff plate 100 may be seen. In the embodiment shown herein, on the inside wall of scuff plate 100 are a plurality of wall studs 101 extending inwardly and configured to match the spacing of the plurality of frame fixturing holes on the right vertical support 14 of the structural frame 10. In the embodiment shown in FIGS. 39 and 40, there are four studs 101 extending inwardly. It is understood by those skilled in the art that any number of studs could have been used such that this teaching is not to be limited to the precise form shown herein. Similarly, the scuff plate on the left-side would have an identical mirrored construction.

In preferred embodiments, a plurality of fasteners secure the scuff plates 100 on the right and left-sides of the wheeled cart 1 to the structural frame by engaging the plurality of wall studs. In this embodiment, the plurality of fasteners comprises screws. However, in other embodiments, other fasteners may be used such as spring push nuts may be used (alternatively push-on external retaining rings, push-on retaining caps, rectangular push-on external retaining rings, flanged push-on external retaining rings, size-mount external retaining rings, round push nuts, rectangular push nuts, flanged push nuts, speed nuts). It is also possible that bolts, nuts clips, Velcro, tape and other fasteners or fastener types could have been used to attach the scuff plates to the structural frame.

Here, a single scuff plate 100 is used on each side of the wheeled cart 1. However, in other embodiments, multiple scuff plates 100 may be used on each side of the wheeled cart 1 to cover the same area as the single scuff plate 100.

In preferred embodiments, the cross-section of the scuff plate along a horizontal plane passing through the middle of the scuff plate is a semicircular shape. Here, the cross-section of the scuff plate has a flat side that interfaces with the frame of the wheeled cart 1 and an arc that faces outward. The arc creates a scuff plate 100 that has its maximum cross-sectional distance at the center such that the centerline of the scuff plate is the farthest point from the wheeled cart 1.

Although in some embodiments, the scuff plate 100 has an arced outer surface, in other embodiments, the outwardly surface is flat. A flat surface may allow a better surface for advertising, especially if the advertising is molded into the part. In yet other embodiments, the scuff play may have raised ribs or other protrusions sacrificially protecting the rest of the cart sides.

In preferred embodiments, scuff plate 100 is made from a base portion 104 and one or more spring portions 106. Spring portions 106 protrude out from the base 104 and are designed to deflect in towards the base portion 104 under load. Accordingly, spring portions 106 provide protection from shock when the wheeled cart 1 is struck. In the embodiment shown in FIG. 39, spring portions 106 run almost the entire length of the scuff plate 100 and are comprised of fins that are slightly gapped off the base portion 104 with the width of the gap increasing towards the centerline of the scuff plate 100. In other embodiments, other design may be used for spring portion 106 including bumpers made from alternative materials design to absorb shock like rubber or equivalents therefore. In some embodiments, scuff plates 100 are designed without spring portions 106 or other bumpers and are just one continuous piece of similar material.

Because scuff plates 100 may be easily removed from wheeled cart 1 and replaced, in addition to protection for the wheeled cart 1, the scuff plates 100 provide a unique advertising opportunity. In preferred embodiments, a plurality of identical scuff plates may be manufactured and then different graphics may be printed on different scuff plates wherein each different graphic represents a different advertisement. Scuff plates 100 may then be swapped, rotated or interchanged to change the advertisement that appears on the wheeled cart 1. In some embodiments, a particular customer would have an entire fleet of carts all with the same advertisement. In other embodiments, different wheeled carts may have different advertisements on their scuff plates. Having different advertisements may also make selecting a wheeled cart more engaging for customers as they seek out their favorite brands on particular wheeled carts 1.

Moving a line of nested shopping carts stresses the rear wheels and their related components, thereby causing an undesirably fast wearing, particularly when attempts are made to turn the line of nested carts. Raising the rear wheels when the carts are nested avoids any ground contact and facilitates the displacement of the cart lines by eliminating directions restrictions imposed by the rear fixed wheels. Additionally, the life span of the rear wheels is increased because they are no longer subjected to lateral displacements which cause friction and grind them down.

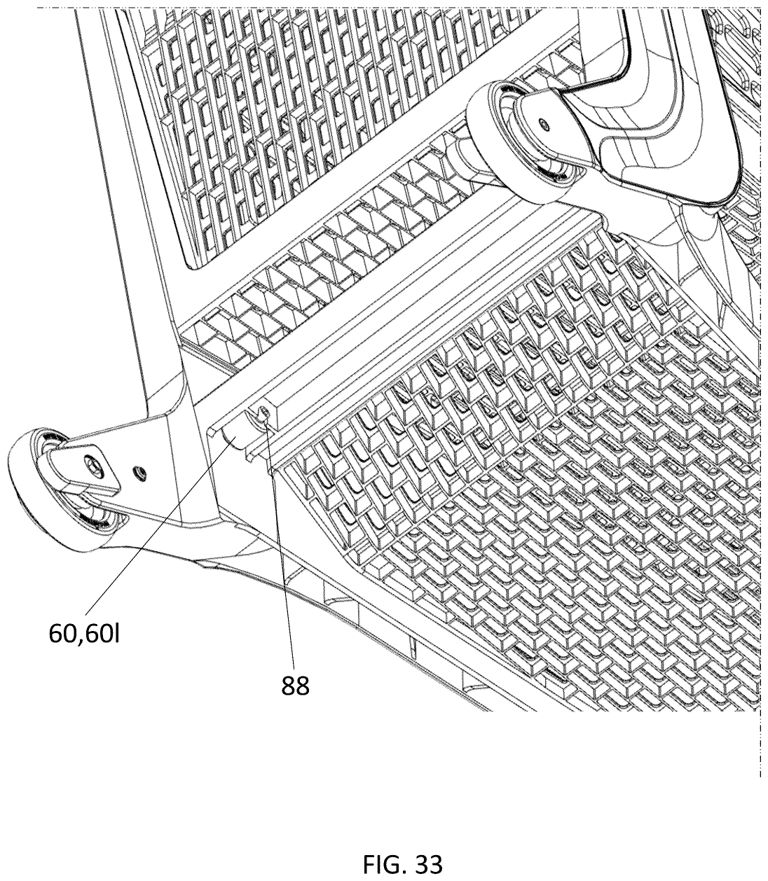

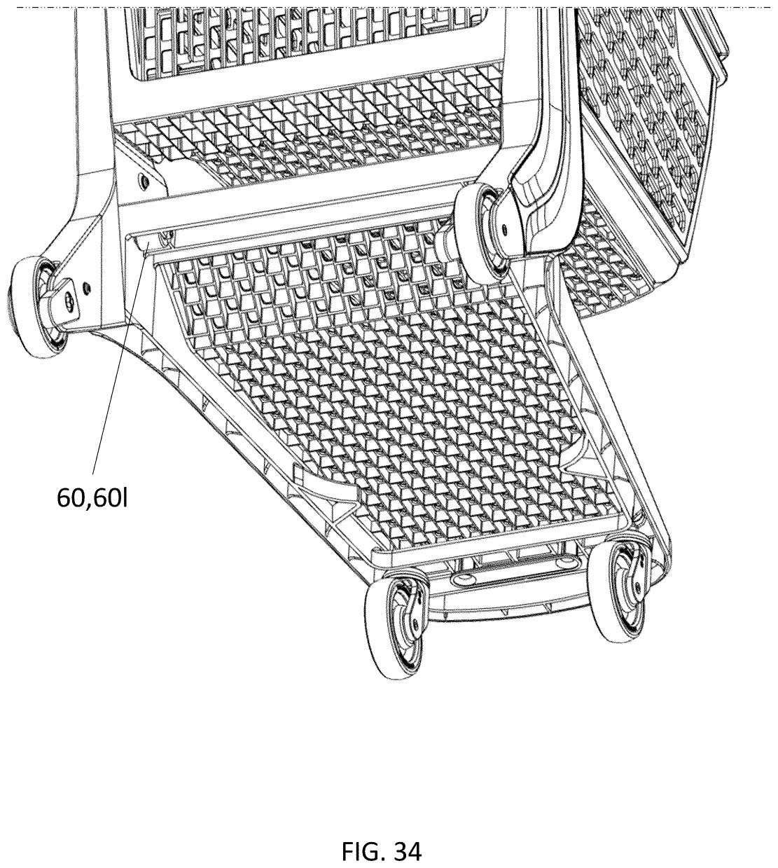

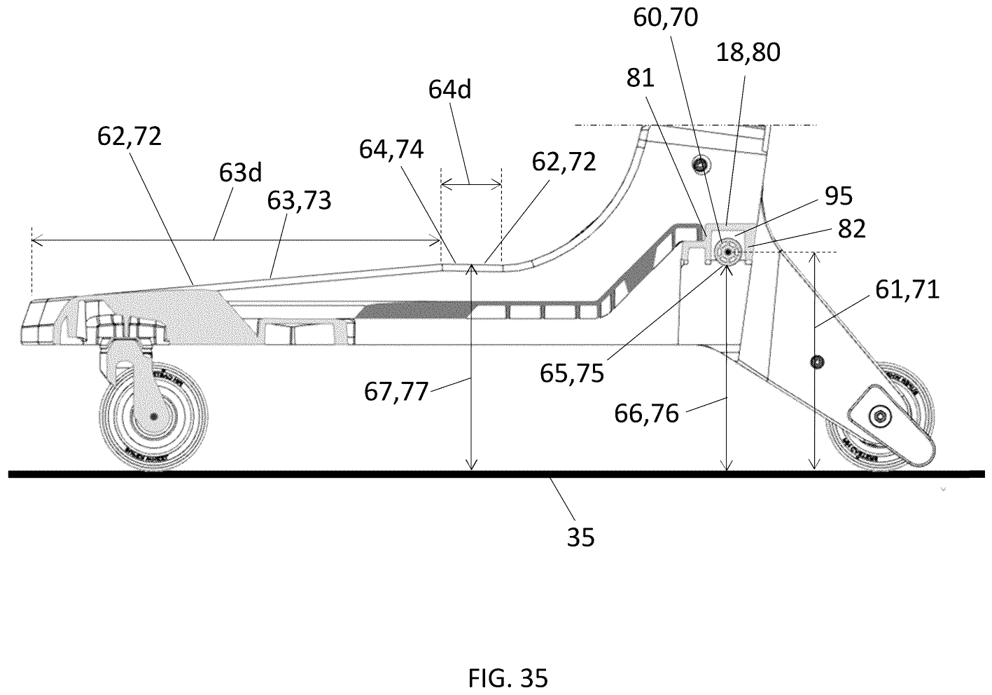

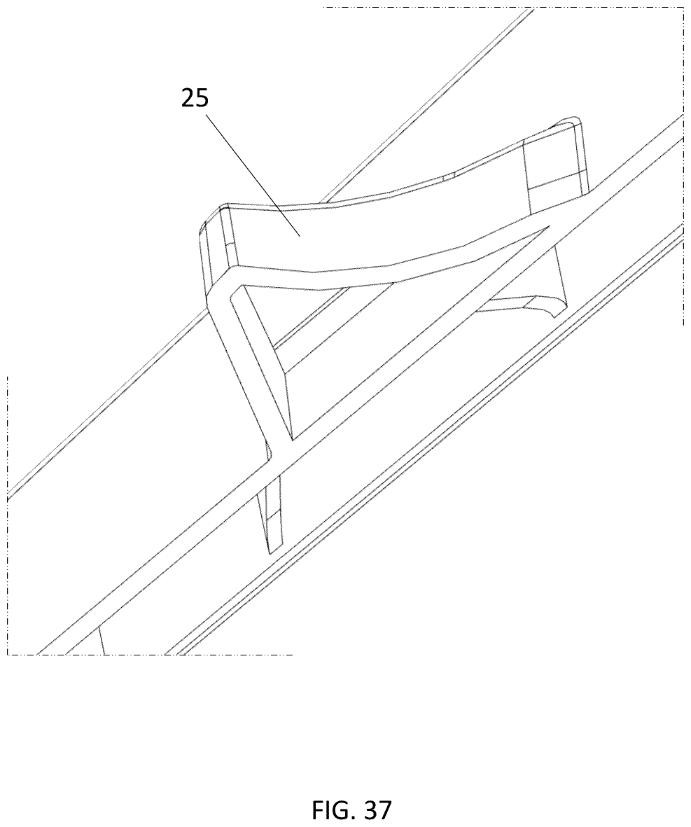

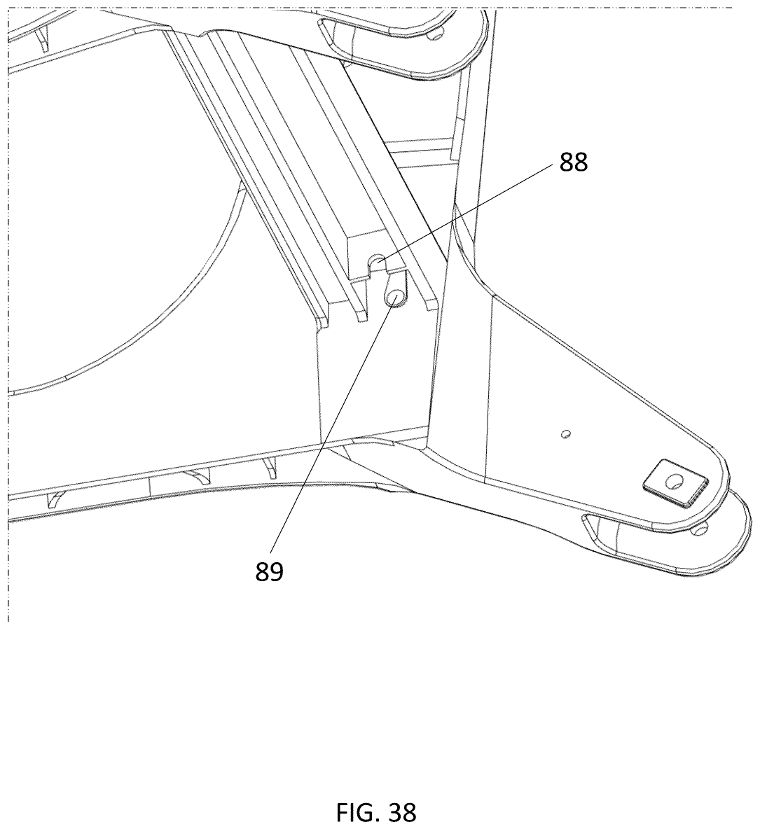

As best shown in FIGS. 33-38, at least one nesting roller 60 is rotatably connected to the structural frame. The at least one nesting roller is disposed a distance 61 above and facing the common ground plane. In this embodiment, the at least one nesting roller is disposed below the rear end cross brace. Alternatively, it is understood by those skilled in the art that the nesting roller could be positioned elsewhere or that the rear end cross brace could be removed while retaining the nesting roller. The cross brace has a horizontal roof portion 80 along with a front wall 81 and rear wall 82 that extend downward providing cover for the nesting roller to be disposed within. This helps keep the nesting roller clean from environmental factors. The at least one nesting roller does not have any parts of the wheeled cart between the at least one nesting roller and the common ground plane, as this area needs to remain free from cart structure to enable nesting to occur.

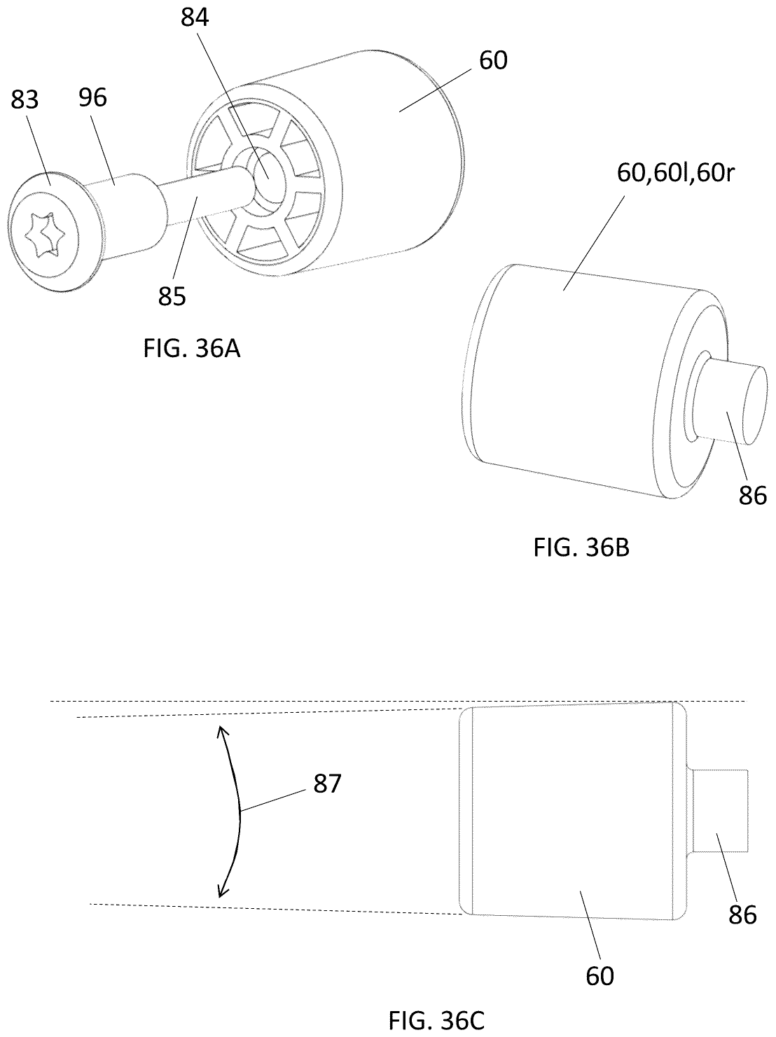

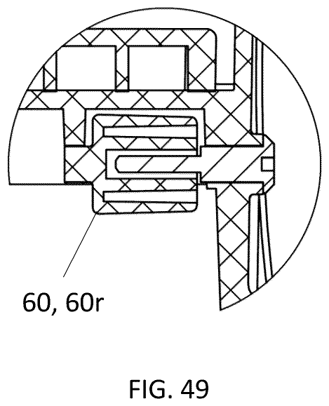

The at least one nesting roller is disposed between the left and the right vertical supports and is secured to the structural frame with the use of a fastener 83. The fastener could be as simple as an axle that allows the roller to roll around. In the embodiments shown herein, and best shown in FIG. 36, the fastener is a shoulder screw having a T30 torx head. It is understood that any head could have been used beyond a torx head such as a 12 point head, a flat head, a hex head, a socket head, a square head and the like. The shoulder screw has a shoulder portion 96 is designed to screw into a hole 84 formed in the roller. The hole has a female threaded inside that threadedly engages a male side 85 thread of the shoulder screw. On the side opposite the hole, the roller has an axle extension 86. The roller is cylindrically shaped but also has a frustoconical shape to its outside running surface, which can be seen as angle 87 in FIG. 36C and is also seen in FIG. 49.

The frustoconical shape serves at least two purposes. First, the frustoconical shape helps in removing the roller part from a mold during manufacture. More importantly, when the nesting roller is rotatably mounted as shown in FIG. 49, the decreasing angle of the nesting roller is directed to the outside of the cart. This means that the right-side nesting roller in FIG. 49 has the decreasing frustoconical shape directed outwardly along the right side 5 of the wheeled cart. Similarly, the left-side nesting roller would have the decreasing frustoconical shape directed outwardly along the left side 4 of the wheeled cart. This is important because the frustoconical shape of the nesting roller of the first wheeled cart 1 acting on the second wheeled cart 2 helps to keep the two wheeled carts in alignment. This is similar in function to how the wheel of a train is slightly angled to keep it aligned along the train tracks.

To attach the nesting roller to the frame, the roller is placed in position within the frame. This means that the axle extension 86 is nested within a U-shaped recess 88 formed in the structural frame. Then, the fastener 83 is placed from an outside of the structural frame and through a through hole 88 formed in the structural frame to then thread into the roller. This means that the nesting roller and fastener rotate as an assembly as they are fixed relative to one another and rotate as one assembly. In other words, the axle of the roller assembly is formed on one end by the axle extension and on the other end by the shoulder of the shoulder screw. This construction enables a simple and cost-effective way to rotatably attach a roller without the need for complicated and expensive roller bearings.

The bottom horizontal support includes an upper surface 62 (or edge) facing the basket, wherein the at least one nesting roller is configured to abut a second upper surface 72 of the bottom horizontal support of the second wheeled cart when the second wheeled cart is nested within the first wheeled cart. The upper surface has an angled portion 63 that extends a distance 63d (400 mm=15.75 inches) which then transitions into a flat portion 64 that extends a distance 64d (70 mm=2.75 inches). The angled portion is angled upwards in relation to the common ground plane extending from the front end towards the rear of the bottom horizontal support. The flat portion is parallel to the common ground plane. It is understood by those skilled in the art that the surfaces described herein can be small enough in surface area to also be considered as an edge. As shown in this embodiment, the flat portion extends a distance of 2.75 inches but it is understood by those skilled in the art that the flat portion could extend a distance of at least 1.0, 1.5, 2.0, 2.5, 2.75, 3 inches or any flat distance. Alternatively, not shown, the flat portion could be angled in a decreasing or increasing manner. Furthermore, in an embodiment not shown, the flat portion 64 may include a slight recess (i.e., pocket, depression) that extends downwardly to help retain the roller within the portion 64. This recess must be small enough such that it does not create a higher than desired force to separate the carts while also being large enough to help retain two carts in a nested position.

The bottommost point 65 of the at least one nesting roller has a distance 66 that is smaller to the common ground plane in comparison to a distance 67 from the flat portion of the upper surface to the common ground plane. This enables, when the second wheeled cart is nested within the wheeled the cart, the at least one nesting roller to engage and roll upon the second upper surface of the second wheeled cart and to raise the left rear wheel and the right rear wheel of the wheeled cart off the common ground plane.

It is understood by those skilled in the art that two nesting rollers are preferably used. Therefore, the at least one nesting roller comprises a left-side nesting roller 60l and a right-side nesting roller 60r. The upper surface comprises a left-side upper surface 68 and a right-side upper surface 69, wherein the left-side roller is configured to engage a second left-side upper surface 78 of the second wheeled cart and the right-side roller is configured to engage a second right-side upper surface 79 of the second wheeled cart when the second wheeled cart is nested within the wheeled the cart.

When the second wheeled cart is nested within the wheeled cart, the at least one nesting stop abuts the front end of the second wheeled cart while the at least one nesting roller is upon the flat portion of the second upper surface of the second wheeled cart. The nesting stops 25 extend inwardly from the bottom horizontal support. The nesting stops are important to prevent the nesting of the carts from coming apart. The structural frame has a curved portion 90 best seen in FIG. 16 that is directly behind the flat portion 64. If the nesting roller was to roll up the curved portion 90, then the raised cart would naturally want to roll down the curved portion and automatically separate the nested carts. This would mean that a customer or worker who tried to nest two carts would be constantly thwarted as the carts would naturally want to separate. To prevent this from happening, the position of the nesting stop is important to prevent the nesting roller from reaching the curved portion and to remain within the length of the flat portion 64. Therefore, the position of the nesting stop is configured to prevent the nesting roller from passing past the flat portion 64 and reaching the curved portion 90.

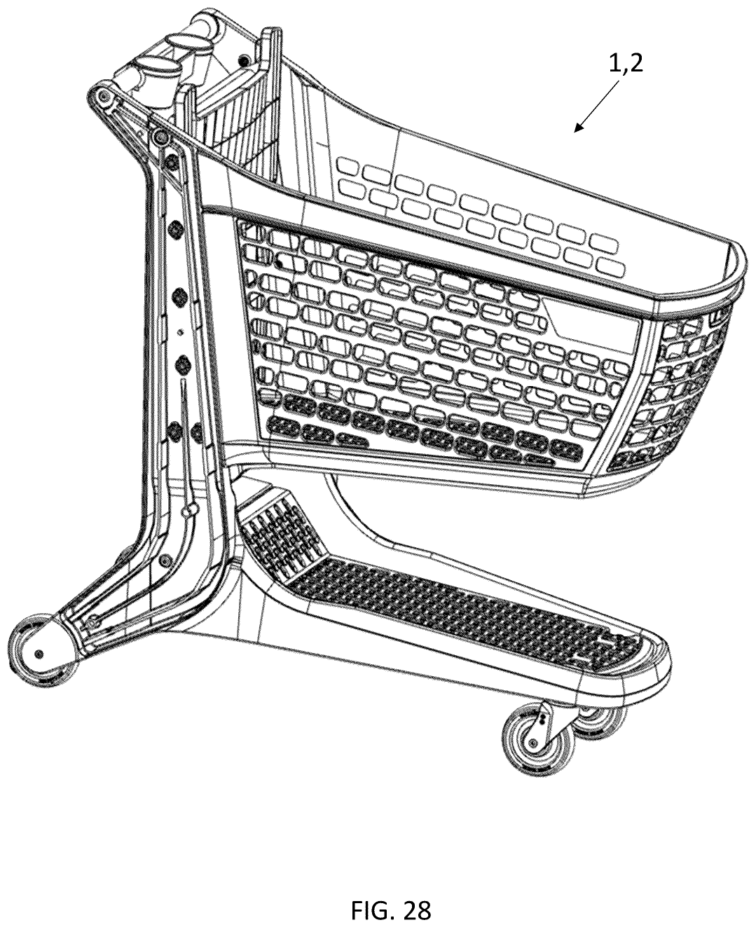

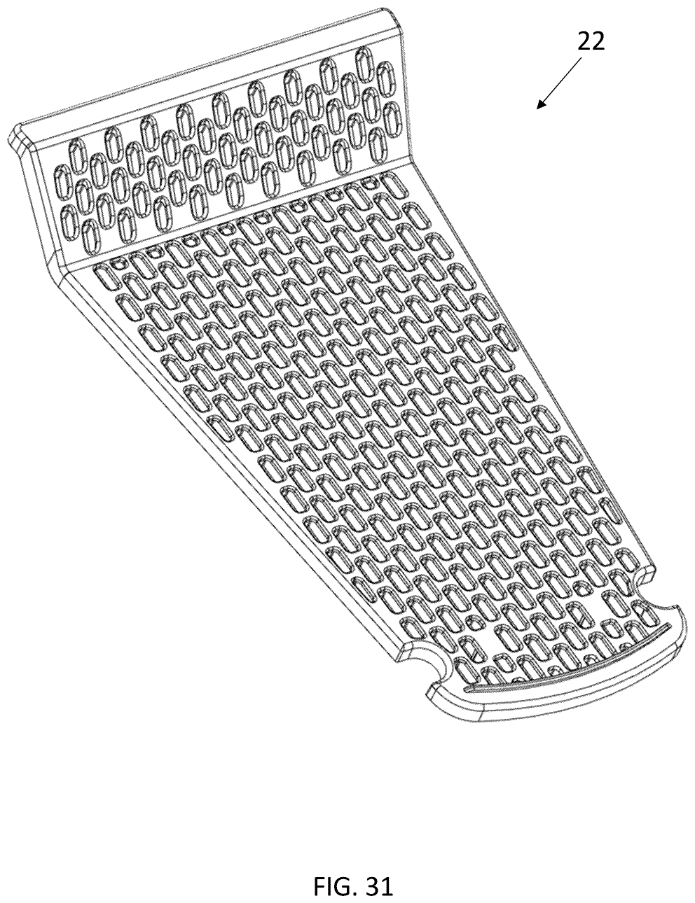

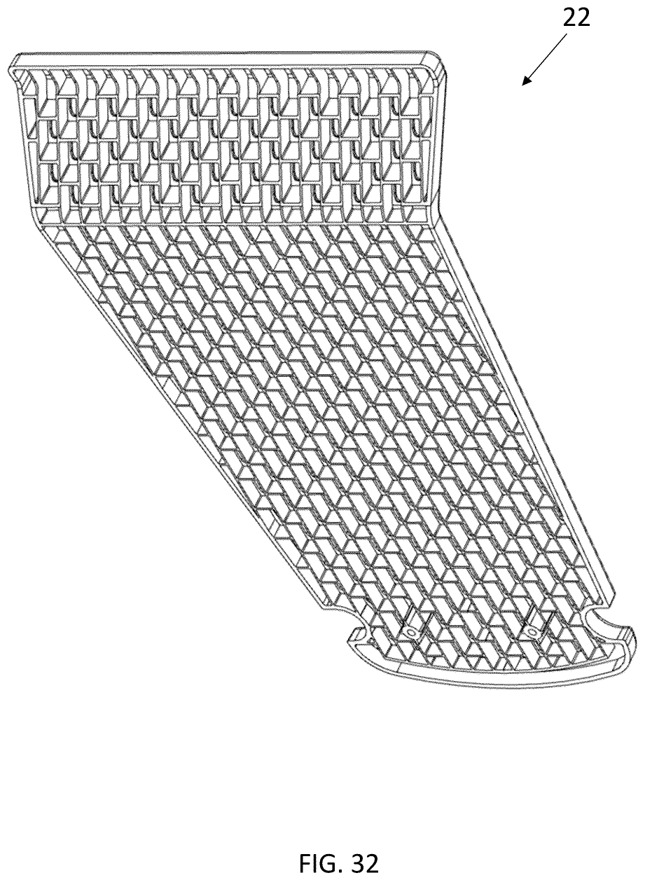

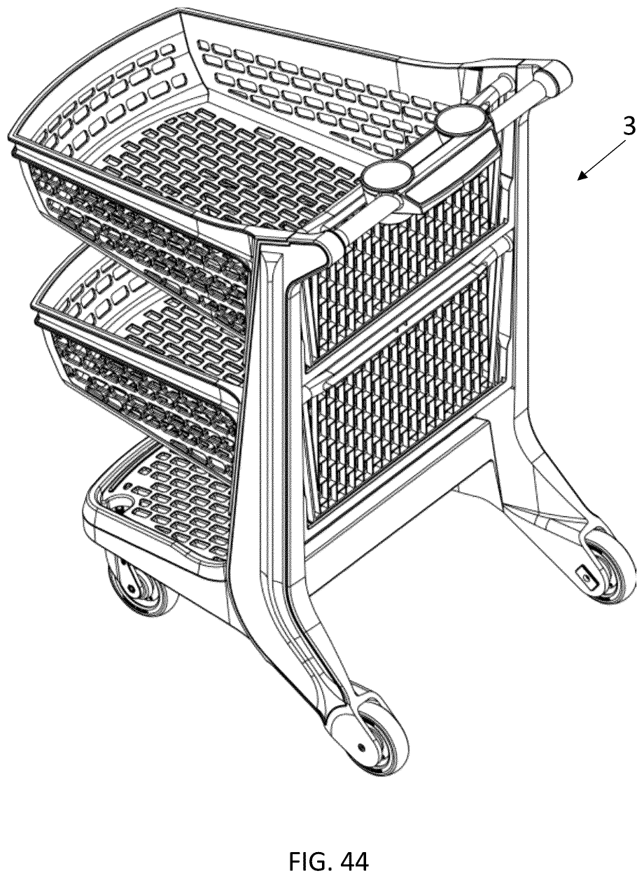

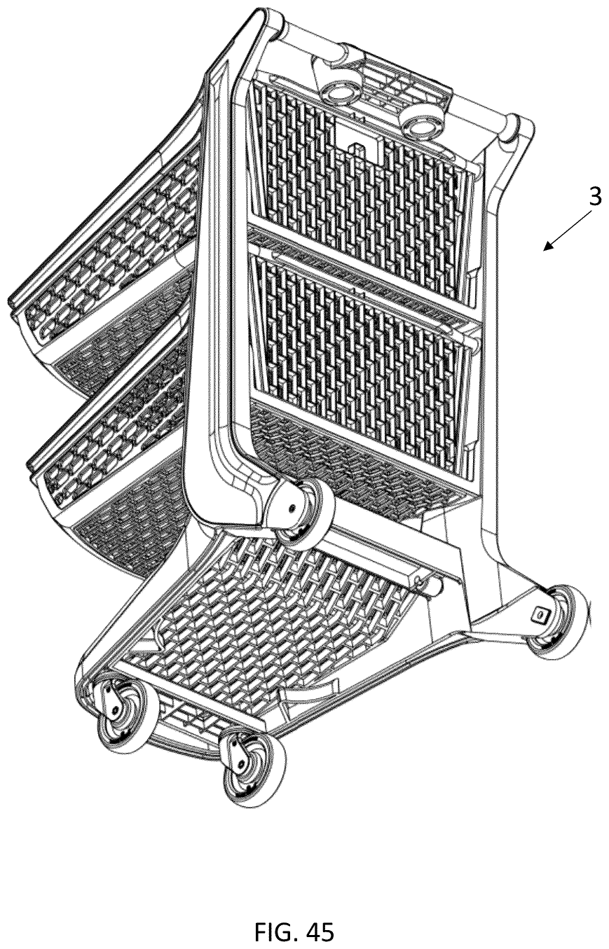

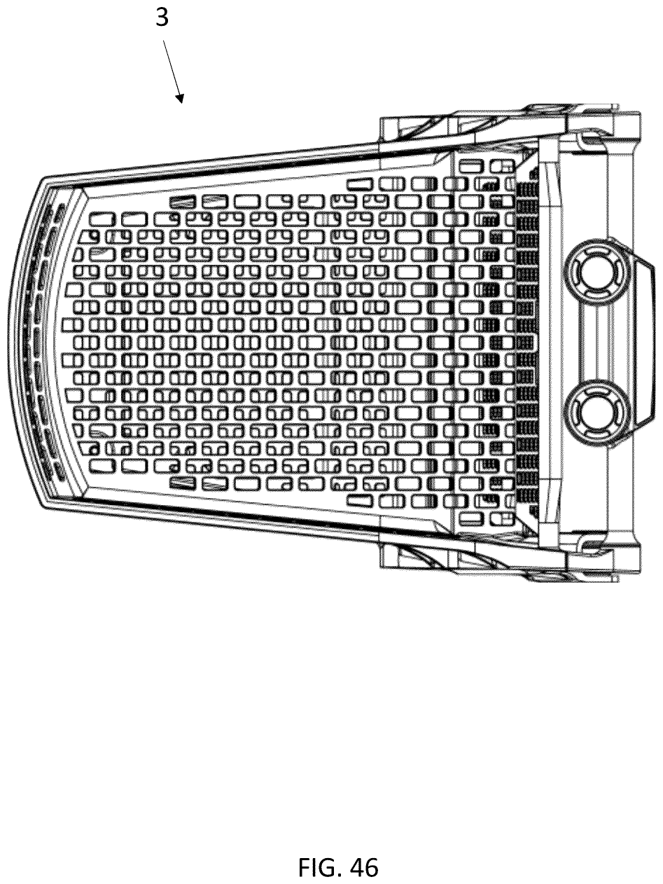

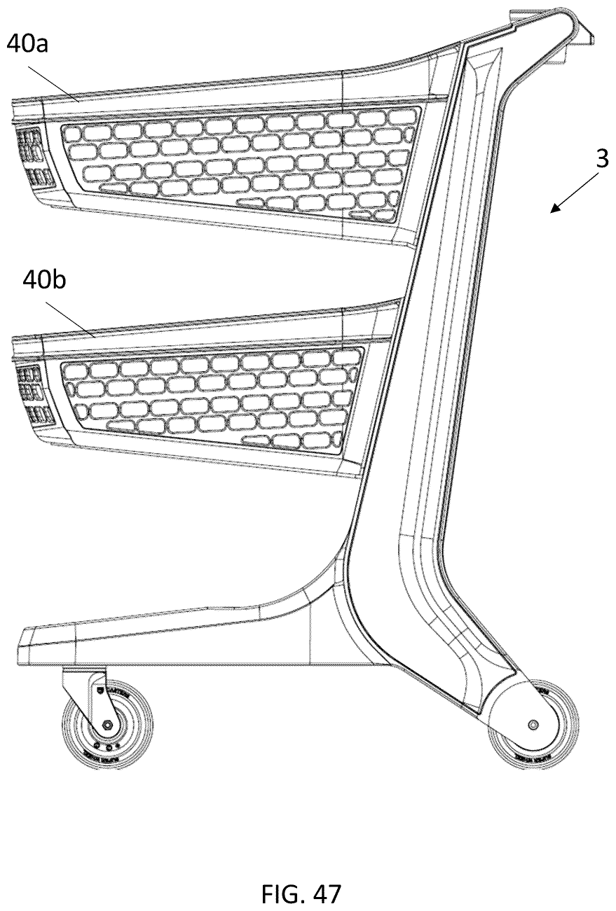

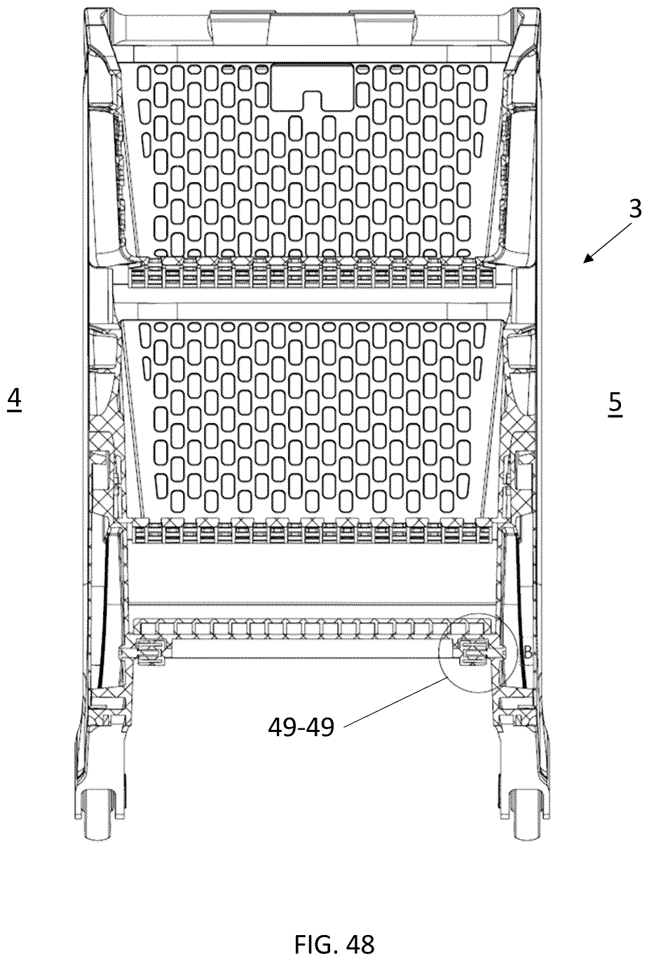

FIGS. 44-49 are another embodiment of the wheeled cart 3 of the present invention. In this embodiment there are two baskets that the structural frame is configured to support, with a top basket 40a above the bottom basket 40b. This embodiment is a bit shorter in length in comparison to the previous embodiment shown in FIGS. 1-43. However, all of the teachings previously discussed herein regarding FIGS. 1-43 apply similarly to this embodiment, such that no further discussion is needed for the sake of brevity.

Although several embodiments have been described in detail for purposes of illustration, various modifications may be made to each without departing from the scope and spirit of the invention. Accordingly, the invention is not to be limited, except as by the appended claims.

What is claimed is:

1. A wheeled cart, comprising:
a structural frame, the structural frame comprising:
a left vertical support;
a right vertical support;
a plurality of wheels rotatably attached to the structural frame;
a basket attached to the structural frame;
a left scuff plate removably coupled to the left vertical support; and
a right scuff plate removably coupled to the right vertical support;
wherein the left scuff plate and right scuff plate comprise the widest points on the
wheeled cart over at least an entire vertical height of the basket.

2. The wheeled cart of claim 1, wherein the left scuff plate and right scuff plate comprise the widest points on the wheeled cart from at least a top of the basket to a bottom of a bottom shelf.

3. The wheeled cart of claim 1, wherein the left scuff plate and the right scuff plate comprise the widest points on the wheeled cart from at least the top of a handle to a bottom of a bottom shelf.

4. The wheeled cart of claim 1, wherein the left scuff plate and the right scuff plate comprise the widest points on the wheeled cart from at least the top of a handle to a top of the plurality of wheels.

5. The wheeled cart of claim 1, wherein the left scuff plate and the right scuff plate are each coupled to the structural frame of the wheeled cart with fasteners.

6. The wheeled cart of claim 1, wherein the left scuff plate and the right scuff plate each comprise a spring portion that runs substantially along a vertical height of the left scuff plate and the right scuff plate.

7. The wheeled cart of claim 1, wherein the left scuff plate covers 90% or more of an outside surface of the left vertical support and the right scuff plate covers 90% or more of an outside surface of the right vertical support.

8. The wheeled cart of claim 1, wherein the left scuff plate covers 95% or more of an outside surface of the left vertical support and the right scuff plate covers 95% or more of an outside surface of the right vertical support.

9. The wheeled cart of claim 1, wherein the left scuff plate and the right scuff plate are comprised of injection molded plastic.

10. The wheeled cart of claim 1, wherein the widest points are comprised by a line running down a vertical length of the left scuff plate and the right scuff plate.

11. The wheeled cart of claim 1, wherein the widest points are comprised by a centerline running down a vertical length of the left scuff plate and the right scuff plate.

12. A wheeled cart, comprising:
a structural frame, the structural frame comprising:
a left vertical support extending at least vertically from a bottom left end to a top left end;
a right vertical support extending at least vertically from a bottom right end to a top right end;
a plurality of wheels rotatably attached to the structural frame;
a basket attached to the structural frame;
a left scuff plate removably coupled to the left vertical support; and
a right scuff plate removably coupled to the right vertical support;
wherein the left scuff plate and right scuff plate comprise the widest points on the wheeled cart from at least the top of a handle to a top of the plurality of wheels.

13. The wheeled cart of claim 12, wherein the left scuff plate and the right scuff plate are each coupled to the structural frame of the wheeled cart with fasteners.

14. The wheeled cart of claim 12, wherein the left scuff plate and the right scuff plate each comprise a spring portion that runs substantially along a vertical height of the left scuff plate and the right scuff plate.

15. The wheeled cart of claim 14, wherein the spring portion runs substantially along the vertical height of the left scuff plate and the right scuff plate.

16. The wheeled cart of claim 12, wherein the left scuff plate covers 90% or more of an outside surface of the left vertical support and the right scuff plate covers 90% or more of an outside surface of the right vertical support.

17. The wheeled cart of claim 12, wherein the left scuff plate covers 95% or more of an outside surface of the left vertical support and the right scuff plate covers 95% or more of an outside surface of the right vertical support.

18. The wheeled cart of claim 12, wherein the widest points are comprised by a line running down a vertical length of the left scuff plate and the right scuff plate.

19. The wheeled cart of claim 12, wherein the widest points are comprised by a centerline running down a vertical length of the left scuff plate and the right scuff plate.

20. A wheeled cart, comprising:
a structural frame, the structural frame comprising:
a left vertical support extending at least vertically from a bottom left end to a top left end;
a right vertical support extending at least vertically from a bottom right end to a top right end;
a plurality of wheels rotatably attached to the structural frame;
a basket attached to the structural frame;
a left scuff plate removably coupled to the left vertical support with fasteners; and
a right scuff plate removably coupled to the right vertical support with fasteners;
wherein the left scuff plate and right scuff plate comprise the widest points on the wheeled cart from at least the top of a handle to a top of the plurality of wheels and wherein the left scuff plate covers 90% or more of an outside surface of the left vertical support and the right scuff plate covers 90% or more of an outside surface of the right vertical support.
